(19) United States
(12) Patent Application Publication
(10) Pub. No.: US 2026/0122611 A1
(43) Pub. Date: Apr. 30, 2026

(54) PAGING USING MULTIPLE INITIAL BANDWIDTH PARTS FOR WIRELESS COMMUNICATION

(71) Applicant: Lenovo (United States) Inc., Morrisville, NC (US)

(72) Inventor: Hyejung Jung, Northbrook, IL (US)

(73) Assignee: Lenovo (United States) Inc., Morrisville, NC (US)

(21) Appl. No.: 18/934,096

(22) Filed: Oct. 31, 2024

(51) Int. Cl. H04W 68/00; H04L 5/00; H04W 72/232

(52) U.S. Cl. CPC H04W 68/005; H04L 5/0053; H04L 5/0094; H04W 72/232

(57) ABSTRACT

Various aspects of the present disclosure relate to paging using multiple initial bandwidth parts (BWPs) for wireless communication. A user equipment (UE) receives a first signaling indicating a plurality of initial bandwidth parts (BWPs) of a cell. The UE selects, based at least in part on an identity (ID) of the UE, an initial BWP from the plurality of initial BWPs, and monitors paging downlink control information (DCI) in the selected initial BWP of the cell.

### TECHNICAL FIELD

The present disclosure relates to wireless communications, and more specifically to paging using multiple initial bandwidth parts (BWPs) for wireless communication.

### BACKGROUND

A wireless communications system may include one or multiple network communication devices, such as base stations, which may support wireless communications for one or multiple user communication devices, which may be otherwise known as user equipment (UE), or other suitable terminology. The wireless communications system may support wireless communications with one or multiple user communication devices by utilizing resources of the wireless communication system (e.g., time resources (e.g., symbols, slots, subframes, frames, or the like) or frequency resources (e.g., subcarriers, carriers, or the like). Additionally, the wireless communications system may support wireless communications across various radio access technologies including third generation (3G) radio access technology, fourth generation (4G) radio access technology, fifth generation (5G) radio access technology, among other suitable radio access technologies beyond 5G (e.g., sixth generation (6G)).

### SUMMARY

An article “a” before an element is unrestricted and understood to refer to “at least one” of those elements or “one or more” of those elements. The terms “a,” “at least one,” “one or more,” and “at least one of one or more” may be interchangeable. As used herein, including in the claims, “or” as used in a list of items (e.g., a list of items prefaced by a phrase such as “at least one of” or “one or more of” or “one or both of”) indicates an inclusive list such that, for example, a list of at least one of A, B, or C means A or B or C or AB or AC or BC or ABC (i.e., A and B and C). By way of another example, a list of at least one of A; B; or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on”. Further, as used herein, including in the claims, a “set” may include one or more elements.

Some implementations of the method and apparatuses described herein may further include a UE for wireless communication. The UE receives a first signaling indicating a plurality of initial bandwidth parts (BWPs) of a cell; selects, based at least in part on an identity (ID) of the UE, an initial BWP from the plurality of initial BWPs; monitors paging downlink control information (DCI) in the selected initial BWP of the cell.

In some implementations of the method and apparatuses described herein, the UE detects a synchronization signal block (SSB) of the cell on a first synchronization raster entry; decodes a physical broadcast channel (PBCH) associated with the SSB; and determines, based at least in part on the PBCH, that the cell is not barred and that the SSB has an associated system information block Type1 (SIB1) of the cell in a first initial BWP associated with the first synchronization raster entry, where to receive the first signaling is to receive the SIB1 in the first initial BWP, and where the SIB1 includes the indication of the plurality of initial BWPs. Additionally, or alternatively, the selected initial BWP includes a second initial BWP, and the UE acquires an extended SIB1 in the second initial BWP; and uses parameters configured in the extended SIB1 of the second initial BWP for monitoring the paging DCI in the second initial BWP. Additionally, or alternatively, the UE detects a first SSB of a cell on a first synchronization raster entry; decodes a PBCH associated with the first SSB; determines, based at least in part on the PBCH, that the cell is not barred, that the first SSB is associated with an extended SIB1 of the cell in a first initial BWP associated with the first synchronization raster entry, and that a SIB1 of the cell is transmitted in a second initial BWP associated with a second synchronization raster entry; detects a second SSB of the cell on the second synchronization raster entry; and receives the SIB1 of the cell in the second initial BWP, where to receive the first signaling is to receive the SIB1 in the second initial BWP, and where the SIB1 includes the indication of the plurality of initial BWPs. Additionally, or alternatively, to select the initial BWP is to select the initial BWP based at least in part on the ID of the UE and at least one of a discontinuous reception (DRX) cycle of the UE, a number of initial BWPs in the plurality of initial BWPs, a number of total paging frames in the DRX cycle of the UE per initial BWP, and a number of paging occasions for a paging frame (PF) per initial BWP. Additionally, or alternatively, the UE determines a PF of the UE based at least in part on the ID of the UE, an index of the selected initial BWP, a DRX cycle of the UE, a number of initial BWPs in the plurality of initial BWPs, and a number of total paging frames in the DRX cycle of the UE per initial BWP; and determines a paging occasion of the UE based at least in part on the ID of the UE, the index of the selected initial BWP, the number of initial BWPs in the plurality of initial BWPs, the number of total paging frames in the DRX cycle of the UE per initial BWP, and a number of paging occasions for a PF per initial BWP.

Some implementations of the method and apparatuses described herein may further include a UE for wireless communication. The UE receives a first signaling indicating a plurality of synchronization raster entries of a cell, where each of the plurality of synchronization raster entries is associated with a distinctive initial bandwidth part (BWP) of a plurality of initial BWPs of the cell; selects, based at least in part on an ID of the UE, a synchronization raster entry from the plurality of synchronization raster entries; determines one or more parameters for an initial BWP of the cell associated with the selected synchronization raster entry; monitors paging DCI based at least in part on the determined parameters for the initial BWP of the cell.

In some implementations of the method and apparatuses described herein, the UE detects a SSB of the cell on the selected synchronization raster entry; decodes a PBCH associated with the SSB; determines, based at least in part on the PBCH, that the cell is not barred and that the SSB has an associated SIB1 of the cell, where the first signaling is received at least in part in the PBCH; and receives the SIB1 in the initial BWP associated with the selected synchronization raster entry upon selection of the synchronization raster entry, where the SIB1 includes the one or more parameters for the initial BWP. Additionally, or alternatively, the UE detects a first SSB of the cell on a first synchronization raster entry of the plurality of synchronization raster entries of the cell, where the selected synchronization raster entry is a second synchronization raster entry, and where the first synchronization raster entry is different from the second synchronization raster entry; decodes a PBCH associated with the first SSB; determines, based at least in part on the PBCH, that the cell is not barred and that the first SSB has an associated SIB1 of the cell in a first initial BWP associated with the first synchronization raster entry, where the first signaling is received at least in part in the PBCH; detects a second SSB of the cell on the second synchronization raster entry upon selection of the second synchronization raster entry; and receives a SIB1 of the cell in a second initial BWP associated with the second synchronization raster entry, where the SIB1 includes the one or more parameters for the second initial BWP. Additionally, or alternatively, to select the synchronization raster entry is to select the synchronization raster entry based at least in part on the ID of the UE and at least one of a DRX cycle of the UE, a number of initial BWPs in the plurality of initial BWPs, a number of total paging frames in the DRX cycle of the UE per initial BWP, and a number of paging occasions for a PF per initial BWP. Additionally, or alternatively, the UE determines a PF of the UE based at least in part on the ID of the UE, an index of the initial BWP, a DRX cycle of the UE, a number of initial BWPs in the plurality of initial BWPs, and a number of total paging frames in the DRX cycle of the UE per initial BWP; and determines a paging occasion of the UE based at least in part on the ID of the UE, the index of the initial BWP, the number of initial BWPs in the plurality of initial BWPs, the number of total paging frames in the DRX cycle of the UE per initial BWP, and a number of paging occasions for a PF per initial BWP.

Some implementations of the method and apparatuses described herein may further include a processor for wireless communication. The processor receives a first signaling indicating a plurality of initial BWPs of a cell; selects, based at least in part on an ID of a UE that includes the processor, an initial BWP from the plurality of initial BWPs; monitors paging DCI in the selected initial BWP of the cell.

In some implementations of the method and apparatuses described herein, the processor detects a SSB of the cell on a first synchronization raster entry; decodes a PBCH associated with the SSB; and determines, based at least in part on the PBCH, that the cell is not barred and that the SSB has an associated SIB1 of the cell in a first initial BWP associated with the first synchronization raster entry, where to receive the first signaling is to receive the SIB1 in the first initial BWP, and where the SIB1 includes the indication of the plurality of initial BWPs. Additionally, or alternatively, the selected initial BWP includes a second initial BWP, and the processor acquires an extended SIB1 in the second initial BWP; and uses parameters configured in the extended SIB1 of the second initial BWP for monitoring the paging DCI in the second initial BWP. Additionally, or alternatively, the processor detects a first SSB of a cell on a first synchronization raster entry; decodes a PBCH associated with the first SSB; determines, based at least in part on the PBCH, that the cell is not barred, that the first SSB is associated with an extended SIB1 of the cell in a first initial BWP associated with the first synchronization raster entry, and that a SIB1 of the cell is transmitted in a second initial BWP associated with a second synchronization raster entry; detects a second SSB of the cell on the second synchronization raster entry; and receives the SIB1 of the cell in the second initial BWP, where to receive the first signaling is to receive the SIB1 in the second initial BWP, and where the SIB1 includes the indication of the plurality of initial BWPs. Additionally, or alternatively, to select the initial BWP is to select the initial BWP based at least in part on the ID of the UE and at least one of a DRX cycle of the UE, a number of initial BWPs in the plurality of initial BWPs, a number of total paging frames in the DRX cycle of the UE per initial BWP, and a number of paging occasions for a PF per initial BWP.

Some implementations of the method and apparatuses described herein may further include a processor for wireless communication. The processor receives a first signaling indicating a plurality of synchronization raster entries of a cell, where each of the plurality of synchronization raster entries is associated with a distinctive initial BWP of a plurality of initial BWPs of the cell; selects, based at least in part on an ID of a UE that includes the processor, a synchronization raster entry from the plurality of synchronization raster entries; determines one or more parameters for an initial BWP of the cell associated with the selected synchronization raster entry; monitors paging DCI based at least in part on the determined parameters for the initial BWP of the cell.

In some implementations of the method and apparatuses described herein, the processor detects a SSB of the cell on the selected synchronization raster entry; decodes a PBCH associated with the SSB; determines, based at least in part on the PBCH, that the cell is not barred and that the SSB has an associated SIB1 of the cell, where the first signaling is received at least in part in the PBCH; and receives the SIB1 in the initial BWP associated with the selected synchronization raster entry upon selection of the synchronization raster entry, where the SIB1 includes the one or more parameters for the initial BWP. Additionally, or alternatively, the processor detects a first SSB of the cell on a first synchronization raster entry of the plurality of synchronization raster entries of the cell, where the selected synchronization raster entry is a second synchronization raster entry, and where the first synchronization raster entry is different from the second synchronization raster entry; decodes a PBCH associated with the first SSB; determines, based at least in part on the PBCH, that the cell is not barred and that the first SSB has an associated SIB1 of the cell in a first initial BWP associated with the first synchronization raster entry, where the first signaling is received at least in part in the PBCH; detects a second SSB of the cell on the second synchronization raster entry upon selection of the second synchronization raster entry; and receives a SIB1 of the cell in a second initial BWP associated with the second synchronization raster entry, where the SIB1 includes the one or more parameters for the second initial BWP. Additionally, or alternatively, the processor determines a PF of the UE based at least in part on the ID of the UE, an index of the initial BWP, a DRX cycle of the UE, a number of initial BWPs in the plurality of initial BWPs, and a number of total paging frames in the DRX cycle of the UE per initial BWP; and determines a paging occasion of the UE based at least in part on the ID of the UE, the index of the initial BWP, the number of initial BWPs in the plurality of initial BWPs, the number of total paging frames in the DRX cycle of the UE per initial BWP, and a number of paging occasions for a PF per initial BWP.

### BRIEF DESCRIPTION OF THE DRAWINGS

FIG. 1 illustrates an example of a wireless communications system in accordance with aspects of the present disclosure.

FIG. 2 illustrates an example of a wireless communications system including multiple initial BWPs in accordance with aspects of the present disclosure.

FIG. 3 illustrates an example of a master information block (MIB) in accordance with aspects of the present disclosure.

FIGS. 4 through 9 illustrate example information elements (IEs) of a SIB1 in accordance with aspects of the present disclosure.

FIG. 10 illustrates an example IE of an extended SIB1 in accordance with aspects of the present disclosure.

FIGS. 11 and 12 illustrate examples of operations with multiple initial BWPs in a cell in accordance with aspects of the present disclosure.

FIGS. 13A, 13B, 14, and 15 illustrate examples of a configuration IE in accordance with aspects of the present disclosure.

FIG. 16 illustrates an example of a UE in accordance with aspects of the present disclosure.

FIG. 17 illustrates an example of a processor in accordance with aspects of the present disclosure.

FIG. 18 illustrates an example of a network equipment (NE) 1800 in accordance with aspects of the present disclosure.

FIGS. 19 through 24 illustrate flowcharts of methods in accordance with aspects of the present disclosure.

### DETAILED DESCRIPTION

In 3rd Generation Partnership Project (3GPP) 5G New Radio (NR), some operating frequency bands such as n41 (2496-2690 MHz), n48 (3550-3700 MHz), n77 (3300-4200 MHz) in frequency range 1 (FR1) can accommodate a base station channel bandwidth up to 100 MHz with a transmission bandwidth of up to 273 resource blocks (RBs). In 6G Radio Access Network (RAN), a centimeter wave spectrum, e.g., 7-15 GHz may be added to operating frequency bands and to support an even larger carrier bandwidth than in 5G.

If a wideband carrier (e.g., 100 MHz or larger with a transmission bandwidth of 273 RBs or larger) is deployed, using as much as frequency resources as needed in a short amount of time, and then turning off the network entity radio head reduces transmission and reception time of a network entity (e.g., a base station) and results in reducing energy usage by the network. Furthermore, reducing an operating radio frequency (RF) bandwidth of the network entity for light traffic loads and rapid expansion of the operating RF bandwidth when needed provides further reduction of energy usage by the network.

The techniques discussed herein describe using multiple initial BWPs per cell. An initial BWP refers to a BWP that is used to perform an initial access process for a UE to establish a connection with a network entity (e.g., a base station). An initial BWP can include various information to establish the connection, such as a CORESET and SIB1. The multiple initial BWPs for a cell allow UEs to be spread across the bandwidth of the wideband carrier and thus allow the UEs to perform the initial access process across the bandwidth of the wideband carrier.

Techniques to flexibly exploit a wideband carrier for initial access procedures and to efficiently configure BWP parameters for energy efficient radio access network are discussed herein. In one or more implementations, initial access for UEs is spread across the wideband carrier by configuring multiple initial BWPs. Even with multiple initial BWP configurations, a resulting SIB1 payload size is kept small enough for broadcasting, since a SIB1 in a default initial BWP provides a minimum amount of information for non-default initial BWPs, and an extended SIB1 in a non-default initial BWP provides corresponding common parameters for the non-default initial BWP. Additionally, or alternatively, a SSB including a PBCH provides information of other synchronization raster entries of a cell. A synchronization raster or synchronization raster entry refers to an indication of one or more frequency positions of a synchronization block (e.g., SSB) transmitted by a network entity. Each SSB including a corresponding PBCH on each synchronization raster entry of the cell indicates a corresponding CORESET/search space used for delivery of a corresponding SIB1 in a corresponding initial BWP. Each SIB1 in each initial BWP provides configuration of common parameters of the corresponding initial BWP.

In one or more implementations, a UE receives a list of BWP-specific dedicated configurations, where each configuration configures a set of dedicated (UE-specific) parameters, which can be associated with one or multiple cell-specific BWP(s). The UE identifies association between a set of dedicated parameters in a configuration and one or multiple cell-specific BWP(s) based on implicit or explicit indication in the configuration. The UE applies the set of dedicated parameters to the corresponding one or multiple cell-specific BWP(s) based on identification.

Using conventional techniques, one initial BWP is configured per cell, and optionally an additional initial BWP can be configured for reduced capability (RedCap) UEs. Accordingly, all normal (not RedCap) UEs in wireless communications systems supporting NR use the same initial BWP for initial access related procedures. In a wideband carrier, distributing broadcast channels/signals and uplink channels/signals related to initial access procedures across a bandwidth of the wideband carrier as discussed herein would be beneficial to reduce always-on time of a network entity and accordingly reduce energy consumption.

Additionally, using conventional techniques, each BWP configuration includes a set of dedicated parameters. When more than one BWP use a same set of dedicated parameters as discussed herein, providing the set of dedicated parameters once with an indication of associated BWP IDs reduces signaling overhead compared to including the same set of dedicated parameters in each BWP configuration.

Techniques for paging in a wideband carrier are also discussed herein. A UE receives an indication of a plurality of initial BWPs of a cell, selects an initial BWP from the plurality of initial BWPs based on a UE identity, and monitors paging DCI in the selected initial BWP of the cell. Additionally, or alternatively, a UE receives an indication of a plurality of synchronization raster entries of a cell, where each synchronization raster entry is associated with an initial BWP of a plurality of initial BWPs of the cell, selects a synchronization raster entry of the cell from the plurality of synchronization raster entries of the cell at least based on a UE identity, determines parameters for an initial BWP of the cell associated with the selected synchronization raster entry of the cell, and monitors paging DCI based on the determined parameters in the initial BWP of the cell.

Using conventional techniques, paging occasions of all UEs in a paging area is evenly distributed in a paging cycle. Thus, “On” duration of a network entity for paging may be long and accordingly may increase network energy consumption. The techniques discussed herein distribute UEs across multiple initial BWPs of a cell for UE's monitoring of paging DCI, which can reduce “On” duration of the network entity for paging and can decrease network energy consumption.

Aspects of the present disclosure are described in the context of a wireless communications system.

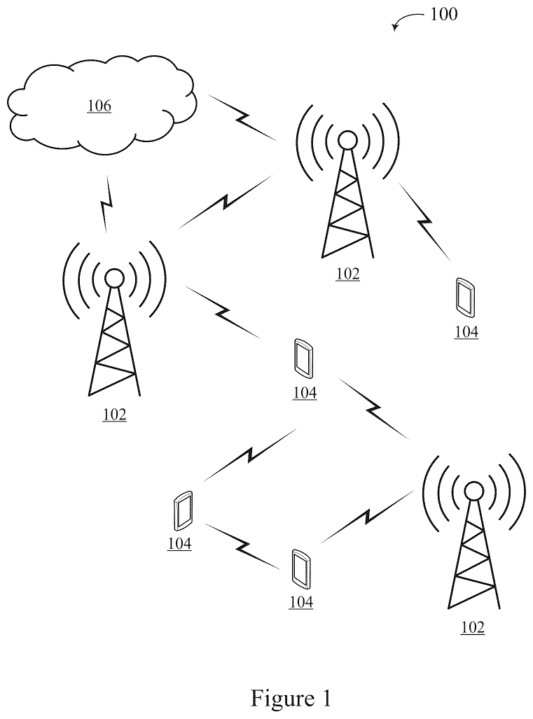

FIG. 1 illustrates an example of a wireless communications system 100 in accordance with aspects of the present disclosure. The wireless communications system 100 may include one or more NE 102, one or more UE 104, and a core network (CN) 106. The wireless communications system 100 may support various radio access technologies. In some implementations, the wireless communications system 100 may be a 4G network, such as an LTE network or an LTE-Advanced (LTE-A) network. In some other implementations, the wireless communications system 100 may be a new radio (NR) network, such as a 5G network, a 5G-Advanced (5G-A) network, or a 5G ultrawideband (5G-UWB) network. In other implementations, the wireless communications system 100 may be a combination of a 4G network and a 5G network, or other suitable radio access technology including Institute of Electrical and Electronics Engineers (IEEE) 802.11 (Wi-Fi), IEEE 802.16 (WiMAX), IEEE 802.20. The wireless communications system 100 may support radio access technologies beyond 5G, for example, 6G. Additionally, the wireless communications system 100 may support technologies, such as time division multiple access (TDMA), frequency division multiple access (FDMA), or code division multiple access (CDMA), etc.

The one or more NE 102 may be dispersed throughout a geographic region to form the wireless communications system 100. One or more of the NE 102 described herein may be or include or may be referred to as a network node, a base station, a network element, a network function, a network entity, a radio access network (RAN), a NodeB, an eNodeB (eNB), a next-generation NodeB (gNB), or other suitable terminology. An NE 102 and a UE 104 may communicate via a communication link, which may be a wireless or wired connection. For example, an NE 102 and a UE 104 may perform wireless communication (e.g., receive signaling, transmit signaling) over a Uu interface.

An NE 102 may provide a geographic coverage area for which the NE 102 may support services for one or more UEs 104 within the geographic coverage area. For example, an NE 102 and a UE 104 may support wireless communication of signals related to services (e.g., voice, video, packet data, messaging, broadcast, etc.) according to one or multiple radio access technologies. In some implementations, an NE 102 may be moveable, for example, a satellite associated with a non-terrestrial network (NTN). In some implementations, different geographic coverage areas associated with the same or different radio access technologies may overlap, but the different geographic coverage areas may be associated with different NE 102.

The one or more UE 104 may be dispersed throughout a geographic region of the wireless communications system 100. A UE 104 may include or may be referred to as a remote unit, a mobile device, a wireless device, a remote device, a subscriber device, a transmitter device, a receiver device, or some other suitable terminology. In some implementations, the UE 104 may be referred to as a unit, a station, a terminal, or a client, among other examples. Additionally, or alternatively, the UE 104 may be referred to as an Internet-of-Things (IoT) device, an Internet-of-Everything (IoE) device, or machine-type communication (MTC) device, among other examples.

A UE 104 may be able to support wireless communication directly with other UEs 104 over a communication link. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link may be referred to as a sidelink. For example, a UE 104 may support wireless communication directly with another UE 104 over a PC5 interface.

An NE 102 may support communications with the CN 106, or with another NE 102, or both. For example, an NE 102 may interface with other NE 102 or the CN 106 through one or more backhaul links (e.g., S1, N2, N6, or other network interface). In some implementations, the NE 102 may communicate with each other directly. In some other implementations, the NE 102 may communicate with each other indirectly (e.g., via the CN 106). In some implementations, one or more NE 102 may include subcomponents, such as an access network entity, which may be an example of an access node controller (ANC). An ANC may communicate with the one or more UEs 104 through one or more other access network transmission entities, which may be referred to as a radio heads, smart radio heads, or transmission-reception points (TRPs).

The CN 106 may support user authentication, access authorization, tracking, connectivity, and other access, routing, or mobility functions. The CN 106 may be an evolved packet core (EPC), or a 5G core (5GC), which may include a control plane entity that manages access and mobility (e.g., a mobility management entity (MME), an access and mobility management functions (AMF)) and a user plane entity that routes packets or interconnects to external networks (e.g., a serving gateway (S-GW), a packet data network (PDN) gateway (P-GW), or a user plane function (UPF)). In some implementations, the control plane entity may manage non-access stratum (NAS) functions, such as mobility, authentication, and bearer management (e.g., data bearers, signal bearers, etc.) for the one or more UEs 104 served by the one or more NE 102 associated with the CN 106.

The CN 106 may communicate with a packet data network over one or more backhaul links (e.g., via an S1, N2, N6, or other network interface). The packet data network may include an application server. In some implementations, one or more UEs 104 may communicate with the application server. A UE 104 may establish a session (e.g., a protocol data unit (PDU) session, or the like) with the CN 106 via an NE 102. The CN 106 may route traffic (e.g., control information, data, and the like) between the UE 104 and the application server using the established session (e.g., the established PDU session). The PDU session may be an example of a logical connection between the UE 104 and the CN 106 (e.g., one or more network functions of the CN 106).

In the wireless communications system 100, the NEs 102 and the UEs 104 may use resources of the wireless communications system 100 (e.g., time resources (e.g., symbols, slots, subframes, frames, or the like) or frequency resources (e.g., subcarriers, carriers)) to perform various operations (e.g., wireless communications). In some implementations, the NEs 102 and the UEs 104 may support different resource structures. For example, the NEs 102 and the UEs 104 may support different frame structures. In some implementations, such as in 4G, the NEs 102 and the UEs 104 may support a single frame structure. In some other implementations, such as in 5G and among other suitable radio access technologies, the NEs 102 and the UEs 104 may support various frame structures (i.e., multiple frame structures). The NEs 102 and the UEs 104 may support various frame structures based on one or more numerologies.

One or more numerologies may be supported in the wireless communications system 100, and a numerology may include a subcarrier spacing and a cyclic prefix. A first numerology (e.g., μ=0) may be associated with a first subcarrier spacing (e.g., 15 kHz) and a normal cyclic prefix. In some implementations, the first numerology (e.g., μ=0) associated with the first subcarrier spacing (e.g., 15 kHz) may utilize one slot per subframe. A second numerology (e.g., μ=1) may be associated with a second subcarrier spacing (e.g., 30 kHz) and a normal cyclic prefix. A third numerology (e.g., μ=2) may be associated with a third subcarrier spacing (e.g., 60 kHz) and a normal cyclic prefix or an extended cyclic prefix. A fourth numerology (e.g., μ=3) may be associated with a fourth subcarrier spacing (e.g., 120 kHz) and a normal cyclic prefix. A fifth numerology (e.g., μ=4) may be associated with a fifth subcarrier spacing (e.g., 240 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally, or alternatively, a time interval of a resource (e.g., a communication resource) may be organized according to slots. For example, a subframe may include a number (e.g., quantity) of slots. The number of slots in each subframe may also depend on the one or more numerologies supported in the wireless communications system 100. For instance, the first, second, third, fourth, and fifth numerologies (i.e., μ=0, μ=1, μ=2, μ=3, μ=4) associated with respective subcarrier spacings of 15 kHz, 30 kHz, 60 kHz, 120 kHz, and 240 kHz may utilize a single slot per subframe, two slots per subframe, four slots per subframe, eight slots per subframe, and 16 slots per subframe, respectively. Each slot may include a number (e.g., quantity) of symbols (e.g., OFDM symbols). In some implementations, the number (e.g., quantity) of slots for a subframe may depend on a numerology. For a normal cyclic prefix, a slot may include 14 symbols. For an extended cyclic prefix (e.g., applicable for 60 kHz subcarrier spacing), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., μ=0) associated with a first subcarrier spacing (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range designations FR1 (410 MHz-7.125 GHZ), FR2 (24.25 GHz-52.6 GHZ), FR3 (7.125 GHZ-24.25 GHZ), FR4 (52.6 GHz-114.25 GHz), FR4a or FR4-1 (52.6 GHz-71 GHz), and FR5 (114.25 GHz-300 GHz). In some implementations, the NEs 102 and the UEs 104 may perform wireless communications over one or more of the operating frequency bands. In some implementations, FR1 may be used by the NEs 102 and the UEs 104, among other equipment or devices for cellular communications traffic (e.g., control information, data). In some implementations, FR2 may be used by the NEs 102 and the UEs 104, among other equipment or devices for short-range, high data rate capabilities.

FR1 may be associated with one or multiple numerologies (e.g., at least three numerologies). For example, FR1 may be associated with a first numerology (e.g., μ=0), which includes 15 kHz subcarrier spacing; a second numerology (e.g., μ=1), which includes 30 kHz subcarrier spacing; and a third numerology (e.g., μ=2), which includes 60 kHz subcarrier spacing. FR2 may be associated with one or multiple numerologies (e.g., at least 2 numerologies). For example, FR2 may be associated with a third numerology (e.g., μ=2), which includes 60 kHz subcarrier spacing; and a fourth numerology (e.g., μ=3), which includes 120 kHz subcarrier spacing.

In some cases, a cell refers to a radio access node in communication with a base station or including a base station. A cell typically has a coverage area, which is a geographic area in which the cell provides wireless connectivity to devices within. Different cells may operate on defined frequencies or frequency bands, referred to as subcarriers. In some examples, a UE 104 establishes a wireless connection with a cell, and subsequently that cell may be referred to as a serving cell of the UE 104.

Reference is made herein to communicating data or information, such as signaling communication resources and/or communications that are transmitted or received between devices. It is to be appreciated that other terms may be used interchangeably with communicating, such as signaling, transmitting, receiving, outputting, forwarding, retrieving, obtaining, and so forth.

According to one or more aspects depicted herein, a UE 104 may receive a first signaling indicating a first SSB of a cell on a first synchronization raster entry and may decode a first PBCH associated with the first SSB. The UE 104 may then identify a second synchronization raster entry of the cell based on the first PBCH. In some cases, the second synchronization raster entry is different from the first synchronization raster entry. In some cases, each of the first synchronization raster entry and the second synchronization raster entry is associated with a different initial BWP of a plurality of initial BWPs of the cell. The UE 104 may then camp on an initial BWP of the plurality of initial BWPs of the cell.

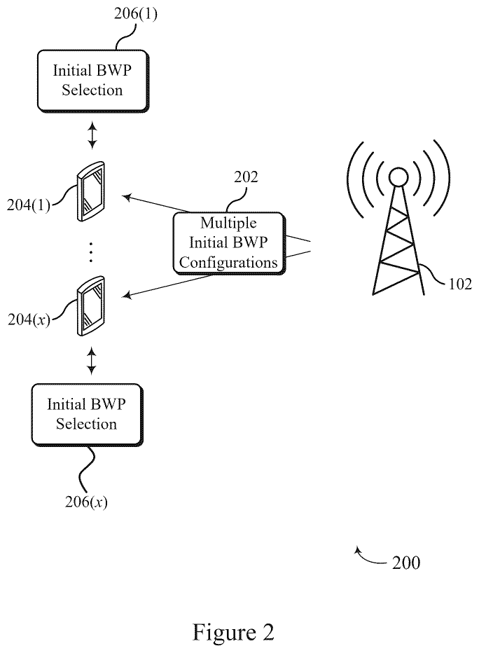

FIG. 2 illustrates an example of a wireless communications system 200 including multiple initial BWPs in accordance with aspects of the present disclosure. A NE 102 communicates (e.g., transmits, sends) configurations for multiple initial BWPs 202 to multiple (x) UEs 204(1), . . . , 204(x). Each of the UEs 204(1), . . . , 204(x) can be a UE 104 of FIG. 1. Each of the UEs 204(1), . . . , 204(x) performs an initial BWP selection 206(1), . . . , 206(x) to select one of the multiple initial BWPs 202 to camp on for the cell that includes the NE 102. Camping on a selected initial BWP of a cell refers to the UE 204 monitoring system and paging information (e.g., paging DCI) for the cell on the selected initial BWP.

UE group-common or cell-specific BWP configuration and switching, semi-persistent scheduling (SPS) physical downlink shared channel (PDSCH) reception/Type-2 configured grant (CG) physical uplink shared channel (PUSCH) transmission/semi-persistent (SP)-channel state information (CSI) reporting on PUSCH without reactivation after switching an active BWP, and group-common signaling based adaptation of a bandwidth of an active BWP for network energy savings are taken into consideration. A UE 104 that switches an active BWP of a cell from a first BWP to a second BWP upon receiving DCI from a network, where the DCI notifies the UE 104 of the cell transitioning to an energy saving state is also taken into consideration. Further, if the UE 104 transmits a wake-up signal in the second BWP to request the cell for transitioning back to a non-energy saving state, the UE 104 switching back its active BWP to one of the first BWP, an initial BWP, and a default BWP is also taken into consideration.

In some wireless communications systems, the following common search space (CSS) sets are used for SIB1 and other system information (SI) delivery, a random access procedure, a small data transmission (SDT) procedure, paging, and paging early indication:
a Type0-PDCCH CSS set on the primary cell of the master cell group (MCG) configured by pdcch-ConfigSIB1 in MIB or by searchSpaceSIB1 in PDCCH-ConfigCommon or by searchSpaceZero in PDCCH-ConfigCommon for a DCI format 1_0 with cyclic redundancy check (CRC) scrambled by a system information radio network temporary identifier (SI-RNTI),
a TypeOA-PDCCH CSS set configured by searchSpaceOtherSystemInformation in PDCCH-ConfigCommon for a DCI format 1_0 with CRC scrambled by a SI-RNTI on the primary cell of the MCG,
a Type1-PDCCH CSS set configured by ra-SearchSpace in PDCCH-ConfigCommon for a DCI format with CRC scrambled by a RA-RNTI, a MsgB-RNTI, or a temporary cell radio network temporary identifier (TC-RNTI) on the primary cell,
a Type1A-PDCCH CSS set configured by sdt-SearchSpace in PDCCH-ConfigCommon for a DCI format with CRC scrambled by a cell radio network temporary identifier (C-RNTI) or a configured scheduling radio network temporary identifier (CS-RNTI) on the primary cell,
a Type2-PDCCH CSS set configured by pagingSearchSpace in PDC CH-ConfigCommon for a DCI format 1_0 with CRC scrambled by a P-RNTI on the primary cell of the MCG,
a Type2A-PDCCH CSS set configured by pei-SearchSpace in pei-ConfigBWP for a DCI format 2_7 with CRC scrambled by a permanent equipment identifier radio network temporary identifier (PEI-RNTI) on the primary cell of the MCG.

In some wireless communications systems supporting NR, a UE 104 can be UE-specifically configured with up to 4 downlink (DL) BWPs including an initial DL BWP for reception and up to 4 uplink (UL) BWPs including an initial UL BWP for transmission in a serving cell. If the UE 104 is not provided with an initial DL BWP configuration, the initial DL BWP is defined by a location and number of contiguous physical resource blocks (PRBs), starting from a PRB with the lowest index and ending at a PRB with the highest index among PRBs of a CORESET for Type0-PDCCH CSS set, after puncturing if any, and a subcarrier spacing (SCS) and a cyclic prefix (CP) for PDCCH reception in the CORESET for Type0-PDCCH CSS set. The UE 104 receives PDCCH and PDSCH in a DL BWP according to a configured SCS and CP length for the DL BWP. The UE 104 transmits physical uplink control channel (PUCCH) and PUSCH in a UL BWP according to a configured SCS and CP length for the UL BWP. The UE 104 does not expect to monitor PDCCH when the UE 104 performs radio resource management (RRM) measurements over a bandwidth that is not within an active DL BWP for the UE 104.

If a BWP indicator field is configured in a DCI format, the BWP indicator field value indicates an active DL BWP, from a configured DL BWP set, for DL receptions. If a BWP indicator field is configured in a DCI format, the BWP indicator field value indicates an active UL BWP, from a configured UL BWP set, for UL transmissions.

In some wireless communications systems supporting NR, a UE 104 in RRC_IDLE or RRC_INACTIVE monitors paging in an initial BWP of a primary cell (PCell). A UE 104 in RRC_CONNECTED monitors for system information (SI) change indication in any paging occasion of a PCell at least once per modification period if the UE 104 is provided with CSS sets including pagingSearchSpace, searchSpaceSIB1 and searchSpaceOtherSystemInformation, on an active BWP. For each DL BWP in a set of DL BWPs of the PCell, the UE 104 can be configured with CORESETs for every type of CSS sets. The UE 104 does not expect to be configured without a CSS set on the PCell on the active DL BWP.

For paging in NR, one or multiple configured paging frames (PFs) and one or multiple configured paging occasions (POs) for a PF are evenly distributed in a paging cycle. In addition, because a same paging message in PDSCH and a same short message in PDCCH are repeated in all transmitted beams of a network entity, PDCCH monitoring occasions for a PO may span multiple radio frames and accordingly, a PO associated with a PF may start in the PF or after the PF. These aspects would expand “On” duration of the network entity and may increase network energy consumption.

Multiple initial BWPs in a wideband carrier are discussed herein. In a wideband carrier, it may be beneficial for network energy savings to distribute broadcast channels/signals and uplink channels/signals related to initial access procedures across a bandwidth of the wideband carrier and accordingly to reduce always-on time of a network entity.

In one or more implementations, a UE 104 detects at least one synchronization signal block (SSB) of a first SSB burst of a cell on a first synchronization raster entry, decodes a physical broadcast channel (PBCH) associated with the first SSB burst of the cell on the first synchronization raster entry, and identifies, based on the decoded PBCH, a CORESET and a PDCCH search space for reception of a corresponding system information block Type1 (SIB1). The UE 104 further identifies at least one second synchronization raster entry of the cell different from the first synchronization raster entry based on decoding of the PBCH and/or based on decoding of PDCCH and/or PDSCH for SIB1 delivery, where each of the at least one second synchronization raster entry of the cell is associated with a distinctive initial BWP from a plurality of initial BWPs of the cell and has transmission of a SSB burst from at least one second SSB burst of the cell. The UE 104 determines a third synchronization raster entry selected from the first synchronization raster entry and the at least one second synchronization raster entry. The UE 104 camps on an initial BWP from the plurality of initial BWPs of the cell, where the initial BWP is associated with the third synchronization raster entry. The UE 104 may retune its local oscillator (LO) to camp on the initial BWP associated with the third synchronization raster entry.

A SSB can include a primary synchronization signal (PSS) and a secondary synchronization signal (SSS), and a SSB burst can include one or multiple SSBs. Additionally, or alternatively, a SSB includes a PSS, a SSS, and a PBCH.

The SIB1 associated with the first SSB burst on the first synchronization raster entry can include information of the plurality of initial BWPs of the cell and information of the at least one second synchronization raster entry. In one example, the information of the plurality of initial BWPs of the cell in the SIB1 includes information of a respective CORESET and a respective PDCCH search space for monitoring an extended SIB1 in each initial BWP of the plurality of initial BWPs of the cell. An extended SIB1 transmitted in an initial BWP of the plurality of initial BWPs of the cell includes common (i.e. cell-specific) parameters for the initial BWP. If the SIB1 does not include an explicit configuration of a CORESET and a PDCCH search space for monitoring an extended SIB1 in a particular initial BWP of the plurality of initial BWPs of the cell, the UE 104 assumes that configuration same as the CORESET and PDCCH search space configuration for monitoring the SIB1 associated with the first synchronization raster entry is applicable to a synchronization raster entry associated with the particular initial BWP. In another example, an initial BWP configuration from a plurality of initial BWP configurations of the cell includes information of an associated synchronization raster entry from a plurality of synchronization raster entries of the cell. In other examples, the information of the plurality of initial BWPs of the cell in SIB1 includes common parameters for the plurality of initial BWPs of the cell.

The PBCH associated with the first SSB burst of the cell on the first synchronization raster entry can include information of the at least one second synchronization raster entry, and the SIB1 associated with the first SSB burst can include information of the plurality of initial BWPs of the cell.

The PBCH associated with the first SSB burst of the cell on the first synchronization raster entry can include information of the at least one second synchronization raster entry. For each of the at least one second synchronization raster entry, a corresponding SSB burst and a corresponding SIB1 are transmitted in a corresponding initial BWP from the plurality of initial BWPs of the cell, where the corresponding SIB1 includes configuration of common parameters of the corresponding initial BWP.

Additionally, or alternatively, a UE 104 detects at least one SSB of a first SSB burst of a cell on a first synchronization raster entry, decodes a first PBCH associated with the first SSB burst of the cell on the first synchronization raster entry, and determines based on the decoded first PBCH that the first SSB burst on the first synchronization raster entry is associated with an extended SIB1 of the cell. Additionally, or alternatively, the UE 104 determines that the first SSB burst on the first synchronization raster entry does not have an associated SIB1 of the cell. The UE 104 further identifies a second synchronization raster entry of the cell different from the first synchronization raster entry, where the second synchronization raster entry is a synchronization raster entry of the cell associated with a SIB1 of the cell. The UE 104 detects at least one SSB of a second SSB burst of the cell on the second synchronization raster entry, decodes a second PBCH associated with the at least one SSB of the second SSB burst of the cell, identifies a CORESET and a PDCCH search space for monitoring a SIB1 based on the decoded second PBCH, and receives the SIB1 based on the identified CORESET and PDCCH search space. The UE 104 identifies a plurality of initial BWPs of the cell and a corresponding plurality of synchronization raster entries of the cell based on the received SIB1. The UE 104 camps on an initial BWP of the cell selected from the plurality of initial BWPs of the cell, where the initial BWP is associated with a third synchronization raster entry and where the plurality of synchronization raster entries includes at least the first, second, and third synchronization raster entries.

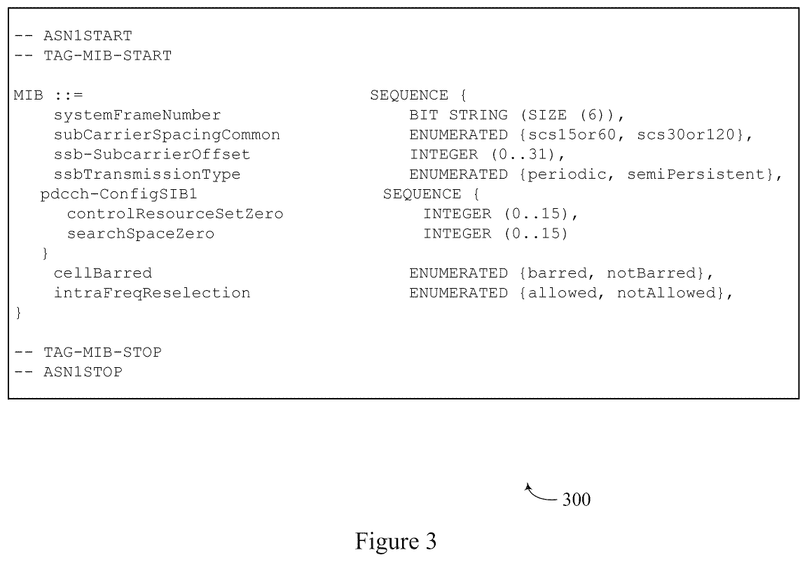

FIG. 3 illustrates an example of a MIB 300 in accordance with aspects of the present disclosure. The MIB 300 includes the system information transmitted on broadcast channel (BCH). The MIB 300 includes a cellBarred field, where a value barred means that the cell is barred. The MIB 300 also includes a ssbTransmissionType field, which indicates whether SSB transmission is periodic or semi-persistent.

The MIB 300 also includes a intraFreqReselection field, which controls cell selection/reselection to intra-frequency cells when the highest ranked cell is barred, or treated as barred by the UE. The MIB 300 also includes a ssb-SubcarrierOffset field, which corresponds to k_{SSB}, which is the frequency domain offset between SSB and the overall resource block grid in number of subcarriers. This field may indicate that SIB1 is absent in this BWP of this cell or may indicate this cell does not provide SIB1 and that there is hence no CORESET #0 configured in MIB. In this case, the field pdcch-ConfigSIB1 may indicate the frequency positions where the UE may find a SS/PBCH block with a control resource set and search space for SIB1 of this cell or for SIB1 of another cell.

The MIB 300 also includes a pdcch-ConfigSIB1 field, which determines a common ControlResourceSet (a CORESET), a common search space and necessary PDCCH parameters for SIB1 reception. If the field ssb-SubcarrierOffset indicates that SIB1 is present in this BWP of this cell, a bandwidth of the common CORESET (e.g., CORESET #0) determines the minimum bandwidth of this BWP of this cell. If the field ssb-SubcarrierOffset indicates that SIB1 is absent in this BWP of this cell, the field pdcch-ConfigSIB1 indicates frequency positions where the UE may find a SS/PBCH block with SIB1 of this cell. If the field ssb-SubcarrierOffset indicates that SIB1 is absent in this cell, the field pdcch-ConfigSIB1 indicates the frequency positions where the UE may find a SS/PBCH block with SIB1 of another cell.

The MIB 300 also includes a controlResourceSetZero field, which indicates a set of parameters of the common CORESET #0 which can be used in any common or UE-specific search space. The MIB 300 also includes a searchSpaceZero field, which indicates a set of parameters of the common SearchSpace #0.

The MIB 300 also includes a subCarrierSpacingCommon field, which indicates subcarrier spacing for SIB1, Msg.2/4 and MsgB for initial access, paging and broadcast SI-messages. If the UE acquires this MIB on an FR1 or FR3-1 (7-15 GHZ) carrier frequency, the value scs15or60 corresponds to 15 kHz and the value scs30or120 corresponds to 30 kHz. If the UE acquires this MIB on an FR2 or FR3-2 (16-24 GHz) carrier frequency, the value scs15or60 corresponds to 60 kHz and the value scs30or120 corresponds to 120 kHz. The MIB 300 also includes a systemFrameNumber field, which indicates the 6 most significant bits (MSBs) of the 10-bit system frame number (SFN). The 4 least significant bits (LSBs) of the SFN are conveyed in the PBCH transport block as part of channel coding (e.g., outside the MIB encoding).

MIB or information bits of a PBCH in an initial BWP from a plurality of initial BWPs of a cell can include an implicit or explicit indication indicating that an associated SIB1 of the cell is absent in the initial BWP. For example, the MIB 300 includes the field ssb-SubcarrierOffset (k_{SSB}), which may indicate that a corresponding SIB1 is absent in this BWP of this cell or may indicate that this cell does not have SIB1.

In one example, if a UE acquires MIB by detecting at least one SSB of a first SSB burst of a cell on a first synchronization raster entry and determines that a corresponding SIB1 is absent in this BWP of this cell and for 24≤K_{SSB}≤27 for FR1 and FR3-1 or for 12≤k_{SSB}≤13 for FR2 and FR3-2, the UE determines a global synchronization channel number (GSCN) of a second synchronization raster entry for a second SSB burst of the cell, which has an associated SIB1 of the cell, as

$${N}_{G S C N}^{first} + {N}_{G S C N}^{S i z e 1} \cdot {N}_{G S C N}^{Offset} , where {N}_{G S C N}^{first}$$

denotes the GSCN of the first synchronization raster entry,

$${N}_{G S C N}^{S i z e 1}$$

is predefined value dependent on a frequency range, and

$${N}_{G S C N}^{Offset}$$

is determined by a combination of k_{SSB}, controlResourceSetZero and searchSpaceZero in pdcch-ConfigSIB1 according to Table 1 (for FR1 and FR3-1) or Table 2 (for FR2 and FR3-2).

Table 1 shows mapping the combination of k_{SSB} and controlResourceSetZero and searchSpaceZero in pdcch-ConfigSIB1 to

$${N}_{G S C N}^{Offset}$$

for indicating a frequency location of SSB with SIB1 of the same cell in FR1 and FR3-1.

TABLE 1

| | 16 × controlResourceSetZero + | ${N}_{GSCN}^{Offset} for a frequency location of$ |
|---|---|---|
| k_{SSB} | searchSpaceZero | SSB with SIB1 of a same cell |
| 24 | 0, 1, ... , 255 | 1, 2, ... , 256 |
| 25 | 0, 1, ... , 255 | 257, 258, ... , 512 |
| 26 | 0, 1, ... , 255 | −1, −2, ... , −256 |
| 27 | 0, 1, ... , 255 | −257, −258, ... , −512 |

Table 2 shows mapping the combination of k_{SSB} and controlResourceSetZero and searchSpaceZero in pdcch-ConfigSIB1 to

$${N}_{G S C N}^{Offset}$$

for indicating a frequency location of SSB with SIB1 of the same cell in FR2 and FR3-2.

TABLE 2

| | 16 × controlResourceSetZero + | ${N}_{GSCN}^{Offset} for a frequency location of$ |
|---|---|---|
| k_{SSB} | searchSpaceZero | SSB with SIB1 of a same cell |
| 12 | 0, 1, ... , 255 | 1, 2, ... , 256 |
| 13 | 0, 1, ... , 255 | −1, −2, ... , −256 |

In another example, if a UE acquires MIB by detecting at least one SSB of a first SSB burst of a cell on a first synchronization raster entry and determines that this cell does not have a corresponding SIB1, and for 28≤K_{SSB}≤31 for FR1 and FR3-1 or for 14≤K_{SSB}≤15 for FR2 and FR3-2, the UE determines a GSCN of a second synchronization raster entry for a SSB burst of another cell with an associated SIB1 as

$${N}_{G S C N}^{first} + {N}_{G S C N}^{S i z e 2} \cdot {N}_{G S C N}^{Offset} , where {N}_{G S C N}^{first}$$

denotes the GSCN of the first synchronization raster entry,

$${N}_{G S C N}^{Size 2}$$

is a predefined value dependent on a frequency range, and

$${N}_{G S C N}^{Offset}$$

is determined by a combination of k_{SSB}, controlResourceSetZero and searchSpaceZero in pdcch-ConfigSIB1 according to Table 3 (for FR1 and FR3-1) or Table 4 (for FR2 and FR3-2).

Table 3 shows mapping the combination of k_{SSB} and controlResourceSetZero and searchSpaceZero in pdcch-ConfigSIB1 to

$${N}_{G S C N}^{Offset}$$

for indicating a frequency location of SSSB with SIB1 of a different cell in FR1 and FR3-1.

TABLE 3

| | 16 × controlResourceSetZero + | ${N}_{GSCN}^{Offset} for a frequency location of$ |
|---|---|---|
| k_{SSB} | searchSpaceZero | SSB with SIB1 of a different cell |
| 28 | 0, 1, ... , 255 | 257, 258, ... , 512 |
| 29 | 0, 1, ... , 255 | 513, 514, ... , 768 |
| 30 | 0, 1, ... , 255 | −257, −258, ... , −512 |
| 31 | 0, 1, ... , 255 | −513, −514, ... , −768 |

Table 4 shows mapping the combination of k_{SSB} and controlResourceSetZero and searchSpaceZero in pdcch-ConfigSIB1 to

$${N}_{G S C N}^{Offset}$$

for indicating a frequency location of SSB with SIB1 of a different cell in FR2 and FR3-2.

TABLE 4

| | 16 × controlResourceSetZero + | ${N}_{GSCN}^{Offset} for a frequency location of$ |
|---|---|---|
| k_{SSB} | searchSpaceZero | SSB with SIB1 of a different cell |
| 14 | 0, 1, ... , 255 | 257, 258, ... , 512 |
| 15 | 0, 1, ... , 255 | −257, −258, ... , −512 |

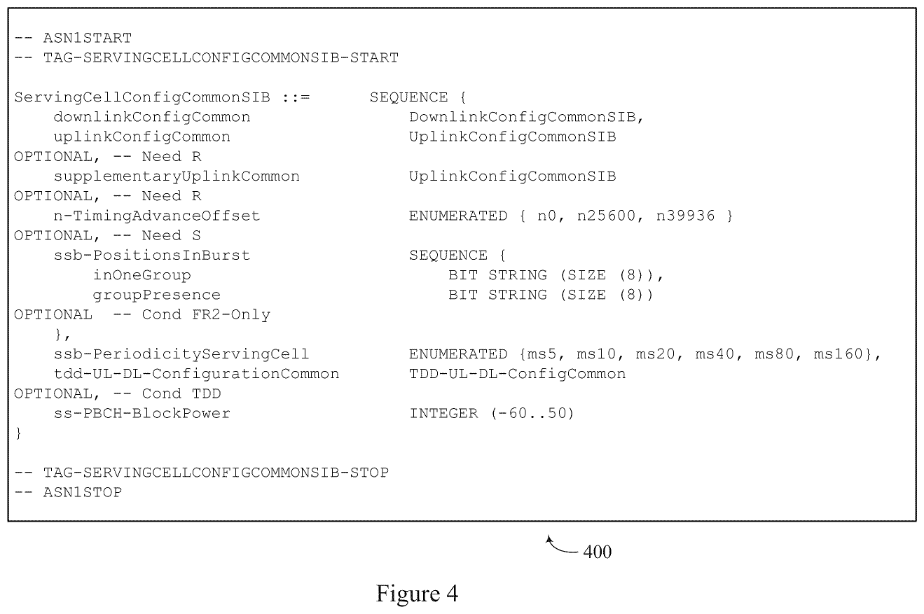

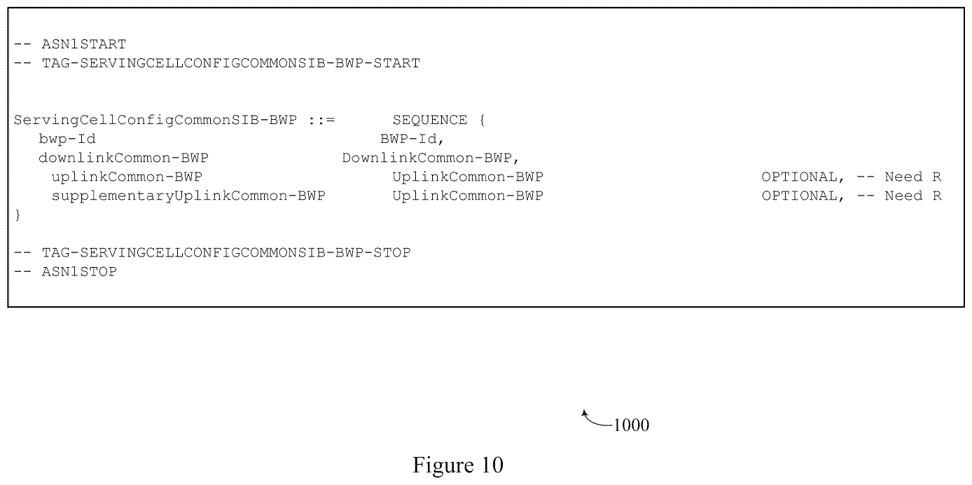

Example implementations of physical layer configuration signaling in SIB1, which enables cell operation with multiple initial BWPs in a wideband carrier, are illustrated in FIGS. 4 through 9. An example implementation of a BWP-specific extended SIB1 is illustrated in FIG. 10, which configures cell-specific parameters of a cell-specific BWP.

FIG. 4 illustrates an example IE of a SIB1 400 in accordance with aspects of the present disclosure. The IE 400 is a ServingCellConfigCommonSIB IE that is used to configure cell specific parameters of a UE's serving cell in SIB1. The ServingCellConfigCommonSIB IE 400 includes a groupPresence field, which is present when a maximum number of SS/PBCH blocks per half frame equals to 64. The first/leftmost bit corresponds to the SS/PBCH index 0-7, the second bit corresponds to SS/PBCH block 8-15, and so on. Value 0 in the bitmap indicates that the SSBs according to inOneGroup are absent. Value 1 indicates that the SS/PBCH blocks are transmitted in accordance with inOneGroup.

The ServingCellConfigCommonSIB IE 400 also includes a inOneGroup field. When a maximum number of SS/PBCH blocks per half frame equals to 4, only the 4 leftmost bits of the field are valid; the UE ignores the 4 rightmost bits. When a maximum number of SS/PBCH blocks per half frame equals to 8, all 8 bits of the field are valid. The first/leftmost bit corresponds to SS/PBCH block index 0, the second bit corresponds to SS/PBCH block index 1, and so on. When maximum number of SS/PBCH blocks per half frame equals to 64, all 8 bits are valid; The first/leftmost bit corresponds to the first SS/PBCH block index in the group (e.g., to SSB index 0, 8, and so on); the second bit corresponds to the second SS/PBCH block index in the group (e.g., to SSB index 1, 9, and so on), and so on. Value 0 in the bitmap indicates that the corresponding SS/PBCH block is not transmitted while value 1 indicates that the corresponding SS/PBCH block is transmitted.

The Serving CellConfigCommonSIB IE 400 also includes a n-TimingAdvance Offset field, which is the N_TA-Offset to be applied for random access on this serving cell. If the field is absent, the UE applies the value defined for the duplex mode and frequency range of this serving cell. The ServingCellConfigCommonSIB IE 400 also includes a ssb-PositionsInBurst field, which indicates the time domain positions of the transmitted SS-blocks in an SS-burst. The Serving CellConfigCommonSIB IE 400 also includes a ss-PBCH-BlockPower field, which indicates an average energy per resource element (EPRE) of resources elements that carry secondary synchronization signals in dBm that the network (NW) used for SSB transmission. The Serving CellConfigCommonSIB IE 400 also includes a ssb-PeriodicityServingCell field, which indicates the SSB periodicity in milliseconds (ms).

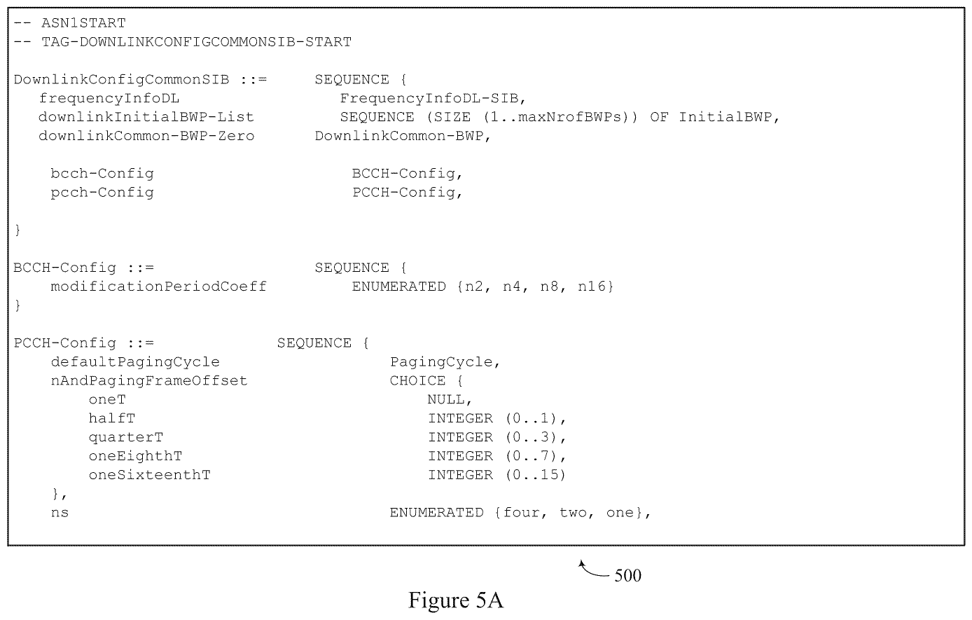

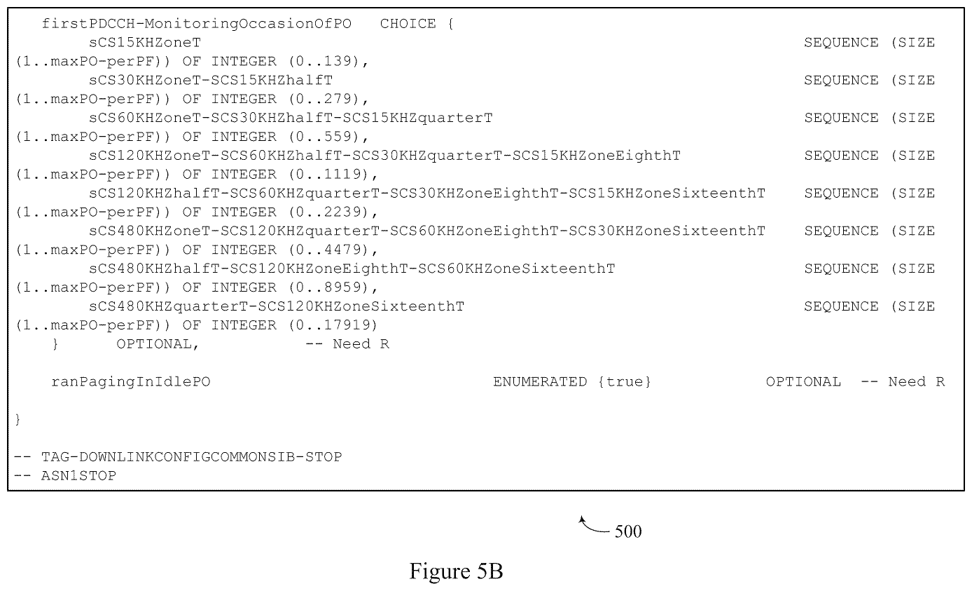

FIGS. 5A and 5B illustrate an example IE of a SIB1 500 in accordance with aspects of the present disclosure. The IE 500 is a DownlinkConfigCommonSIB IE that provides common downlink parameters of a cell. The DownlinkConfigCommonSIB IE includes a bcch-Config, modificationPeriodCoeff field, a frequencyInfoDL-SIB field, a downlinkInitialBWP-List field, a downlinkCommon-BWP-Zero field, and a pcch-Config field.

The bcch-Config, modificationPeriodCoeff field indicates the modification period related configuration. Actual modification period, expressed in number of radio frames m modificationPeriodCoeff*defaultPagingCycle. n2 corresponds to value 2, n4 corresponds to value 4, and so on. The frequencyInfoDL-SIB field indicates basic parameters of a downlink carrier and transmission thereon. The downlinkInitialBWP-List field indicates a list of initial DL BWPs configured in a cell. The downlinkCommon-BWP-Zero field indicates common parameters of a default initial DL BWP (e.g., DL BWP #0). The pcch-Config field indicates the paging related configuration.

The paging control channel configuration (P (CH-Config) field includes a defaultPaging Cycle field, a firstPDCCH-MonitoringOccasionOfPO field, a nAndPagingFrameOffset field, a ns field, and a ranPagingInIdlePO field. The defaultPagingCycle field indicates a default paging cycle, used to derive ‘T’. Value rf32 corresponds to 32 radio frames, value rf64 corresponds to 64 radio frames and so on. The firstPDC CH-MonitoringOccasionOfPO) field points out the first PDCCH monitoring occasion for paging of each PO of the PF.

The nAndPagingFrame Offset field is used to derive the number of total paging frames in T (corresponding to parameter N) and paging frame offset (corresponding to parameter PF_offset). A value of one SixteenthT corresponds to T/16, a value of oneEighthT corresponds to T/8, and so on. If pagingSearchSpace is set to zero and if SS/PBCH block and CORESET multiplexing pattern is 2 or 3:
for ssb-periodicityServing Cell of 5 or 10 ms, N can be set to one of {oneT, halfT, quarterT, one EighthT, one SixteenthT}
for ssb-periodicityServingCell of 20 ms, N can be set to one of {halfT, quarterT, oneEighthT, one SixteenthT}
for ssb-periodicityServingCell of 40 ms, N can be set to one of {quarterT, oneEighthT, one SixteenthT}
for ssb-periodicityServingCell of 80 ms, N can be set to one of {oneEighthT, oneSixteenthT}
for ssb-periodicityServingCell of 160 ms, N can be set to one SixteenthT.

If pagingSearchSpace is set to zero and if SS/PBCH block and CORESET multiplexing pattern is 1, N can be set to one of {halfT, quarterT, oneEighthT, oneSixteenthT}. If pagingSearchSpace is not set to zero, N can be configured to one of {oneT, halfT, quarterT, one EighthT, one SixteenthT}

The ns field indicates a number of paging occasions per paging frame. The ranPagingInIdlePO field indicates that the network supports to send RAN paging in PO that corresponds to the i_s as determined by UE in RRC_IDLE state.

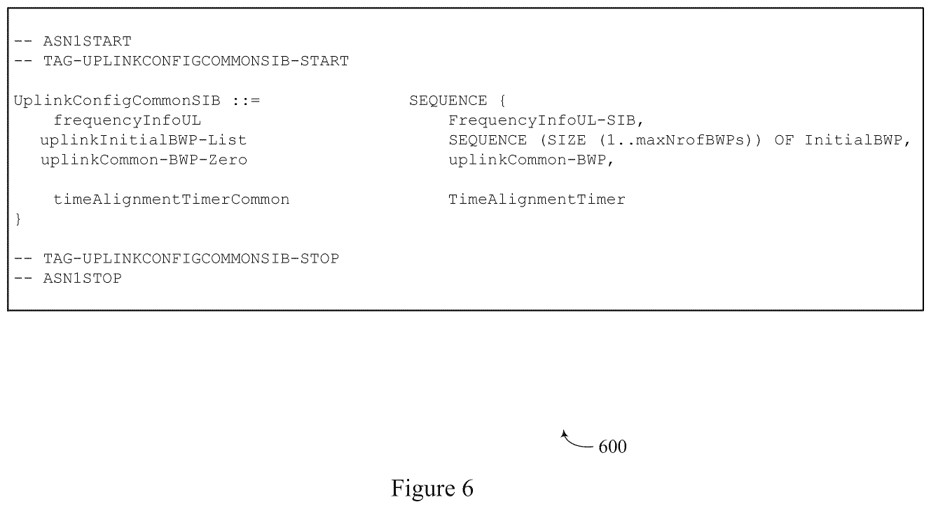

FIG. 6 illustrates an example IE of a SIB1 600 in accordance with aspects of the present disclosure. The IE 600 is an UplinkConfigCommonSIB IE that provides common uplink parameters of a cell.

The UplinkConfigCommonSIB IE 600 includes a frequencyInfol/L field that indicates an absolute uplink frequency configuration and subcarrier specific virtual carriers. The UplinkConfigCommonSIB IE 600 also includes a uplinkInitialBWP-List that indicates a list of initial UL BWPs configured in a cell. InitialBWP configured in DownlinkConfigCommonSIB with the communication direction field ‘bwp-Direction’ set to ‘both’ is also considered as an initial UL BWP, although it is not included in ‘uplinkInitialBWP-List’. The UplinkConfigCommonSIB IE 600 also includes a uplinkCommon-BWP-Zero field that indicates common parameters of a default initial UL BWP (e.g., UL BWP #0).

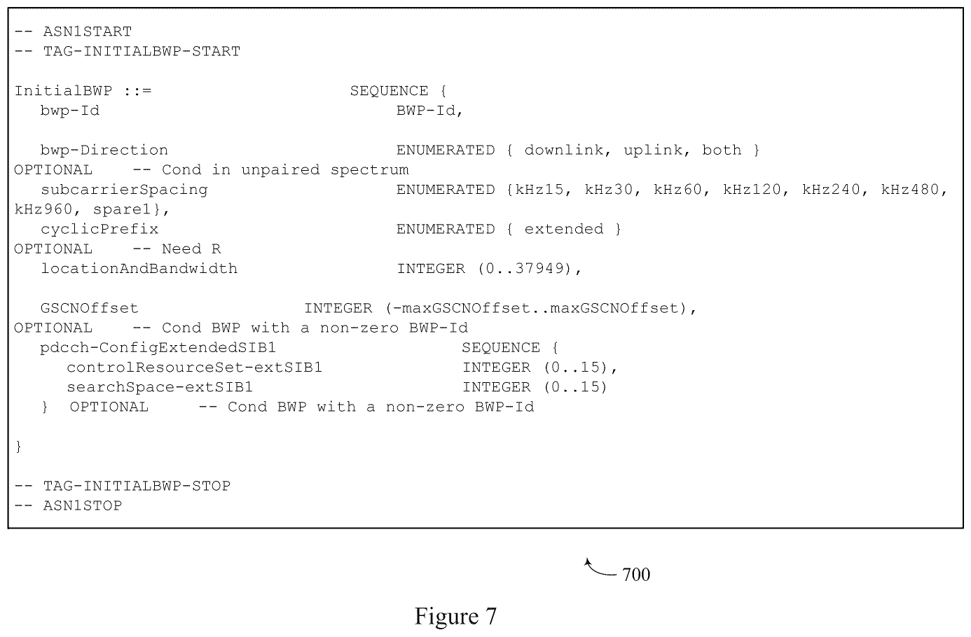

FIG. 7 illustrates an example IE of a SIB1 700 in accordance with aspects of the present disclosure. The IE 700 is an InitialBWP IE that is used to configure a location, a bandwidth, a subcarrier spacing, a cyclic prefix, a communication direction of a cell-specific initial BWP and to provide information of a corresponding synchronization raster entry and common PDCCH parameters for monitoring an extended SIB1 if the initial BWP is a non-default initial BWP.

The InitialBWP IE 700 includes a bwp-ID field that indicates an identifier for this BWP. The identifier identifies a cell-wise DL and/or UL BWP and is a cell-wise DL and/or UL BWP index. The value 0 is reserved for a default initial DL/UL BWP. The InitialBWP IE 700 also includes a bwp-Direction field that indicates communication direction for this BWP. ‘downlink’ indicates that this BWP is a DL BWP, ‘uplink’ indicates that this BWP is a UL BWP, and ‘both’ indicates that this BWP is used for both UL and DL. The InitialBWP IE 700 also includes a cyclicPrefix field that indicates whether to use the extended cyclic prefix for this BWP. If not set, the UE uses the normal cyclic prefix.

The InitialBWP IE 700 also includes a locationAndBandwidth field that indicates frequency domain location and bandwidth of this BWP or this bandwidth configuration. The value of the field shall be interpreted as resource indicator value (RIV) with setting

$${N}_{B W P}^{size} = 600.$$

For time division duplexing (TDD), a BWP-pair (UL BWP and DL BWP with the same bwp-Id) has the same center frequency. The InitialBWP IE 700 also includes a subcarrierSpacing field that indicates subcarrier spacing to be used in this BWP for all channels and reference signals unless explicitly configured elsewhere. The value kHz15 corresponds to 15 KHz, value kHz30 corresponds to 30 KHz, and so on.

The InitialBWP IE 700 also includes a pdcch-ConfigExtendedSIB1 field that determines a common CORESET, a common search space and necessary PDCCH parameters for reception of an extended SIB1. The InitialBWP IE 700 also includes a controlResourceSet-extSIB1 field that indicates a set of parameters of a common CORESET with a CORESET identifier same as this BWP identifier which can be used in any common or UE-specific search space in this BWP. The InitialBWP IE 700 also includes a searchSpace-extSIB1 field that indicates a set of parameters of a common SearchSpace with a search space identifier same as this BWP identifier. The InitialBWP IE 700 also includes a GSCNOffset field that indicates a frequency location of a SS/PBCH block in this BWP in terms of a GSCN offset with respect to a GSCN of a SS/PBCH block with SIB1 of this cell. This field is not included for a default initial BWP (e.g., BWP #0).

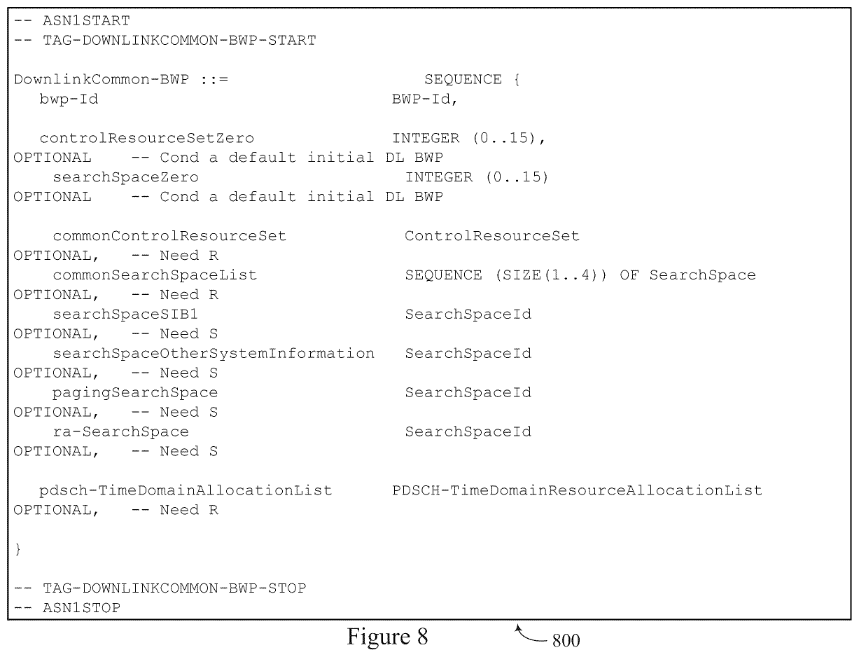

FIG. 8 illustrates an example IE of a SIB1 800 in accordance with aspects of the present disclosure. The IE 800 is a DownlinkCommon-BWP IE that is used to configure common parameters of a cell-specific downlink BWP.

The DownlinkCommon-BWP IE 800 includes a bwp-Id field that indicates an identifier of a cell-specific DL BWP which these downlink common parameters are associated with. The DownlinkCommon-BWP IE 800 also includes a commonControlResourceSet field that indicates an additional common control resource set which may be configured and used for any common or UE-specific search space. If the network configures this field, it uses a ControlResourceSetld other than 0 for this ControlResourceSet. The network configures the commonControlResourceSet in SIB1 so that it is contained in the bandwidth of CORESET #0. The DownlinkCommon-BWP IE 800 also includes a commonSearchSpaceList field that indicates a list of additional common search spaces. If the network configures this field, it uses the SearchSpacelds other than 0. If the field is included, it replaces any previous list, e.g., all the entries of the list are replaced and each of the SearchSpace entries is considered to be newly created and the conditions and Need codes for setup of the entry apply.

The DownlinkCommon-BWP IE 800 also includes a searchSpaceSIB1 field that indicates an ID of the search space for SIB1 message. In the default initial DL BWP of UE's PCell, the network sets this field to 0. If the field is absent, the UE does not receive SIB1 in this BWP. The SIB IE 800 also includes a ra-SearchSpace field that indicates an ID of the Search space for random access procedure. If the field is absent, the UE does not receive random access response (RAR) in this BWP. The DownlinkCommon-BWP IE 800 also includes a searchSpace OtherSystemInformation field that indicates an ID of the Search space for other system information, e.g., SIB2 and beyond. If the field is absent, the UE does not receive other system information in this BWP.

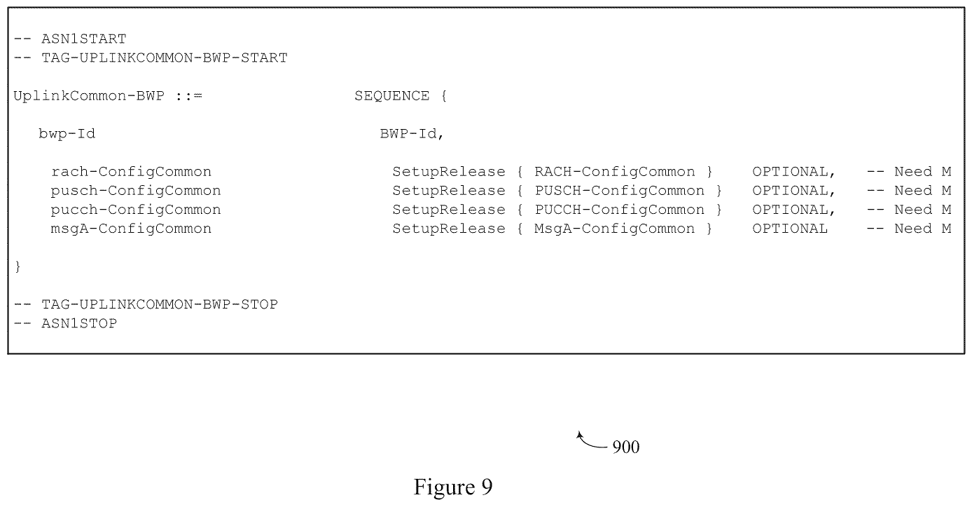

FIG. 9 illustrates an example IE of a SIB1 900 in accordance with aspects of the present disclosure. The IE 900 is an UplinkCommon-BWP IE that is used to configure common parameters of a cell-specific uplink BWP. The UplinkCommon-BWP IE 900 includes a bwp-Id field that indicates an identifier of a cell-specific UL BWP which these uplink common parameters are associated with. The UplinkCommon-BWP IE 900 also includes a msgA-ConfigCommon field that indicates a configuration of the cell specific physical random access channel (PRACH) and PUSCH resource parameters for transmission of MsgA in 2-step random access type procedure.

The UplinkCommon-BWP IE 900 also includes a pucch-ConfigCommon field that indicates cell specific parameters for the PUCCH of this BWP. The UplinkCommon-BWP IE 900 also includes a pusch-ConfigCommon field that indicates cell specific parameters for the PUSCH of this BWP. The UplinkCommon-BWP IE 900 also includes a rach-ConfigCommon field that indicates configuration of cell specific random access parameters which the UE uses for contention based and contention free random access as well as for contention based beam failure recovery in this BWP.

FIG. 10 illustrates an example IE of an extended SIB1 1000 in accordance with aspects of the present disclosure. The IE 1000 is a ServingCellConfigCommonSIB-BWP IE that is used to configure cell-specific parameters of a cell-specific BWP of a UE's serving cell in a BWP-specific extended SIB1.

The ServingCellConfigCommonSIB-BWP IE 1000 includes a bwp-Id field that indicates an identifier of DL and UL BWPs which these common parameters in a BWP-specific extended SIB1 are associated with. The ServingCellConfigCommonSIB-BWP IE 1000 also includes a downlinkCommon-BWP field that indicates common downlink parameters for the DL BWP identified by bwp-Id. The ServingCellConfigCommonSIB-BWP IE 1000 also includes a uplinkCommon-BWP, supplementaryUplinkCommon-BWP field that indicates common uplink parameters for the UL BWP(s) identified by bwp-Id.

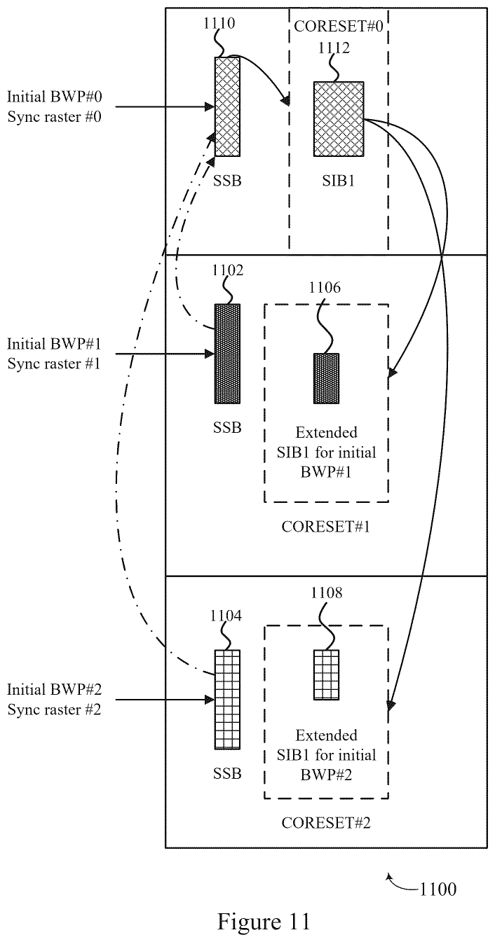

FIG. 11 illustrates an example 1100 of operations with multiple initial BWPs in a cell in accordance with aspects of the present disclosure. The example 1100 reduces on-time of a network entity regarding initial access related signaling and broadcast signal/channel transmission. In multiple beam-based cell operation, a SSB on a synchronization raster entry is replaced with a SSB burst, e.g., a set of SSBs on the synchronization raster entry.

In the example 1100, a SSB 1102 on synchronization raster 1 and a SSB 1104 on synchronization raster 2 do not have a corresponding SIB1 but have a corresponding BWP-specific extended SIB1 1106 and 1108 in the corresponding initial BWP 1 and the corresponding initial BWP 2, respectively. The SSB 1102 on the synchronization raster 1 and the SSB 1104 on the synchronization raster 2 indicate synchronization raster 0, where a SSB 1110 with a corresponding SIB1 1112 of a cell is transmitted. The SSB 1110 on the synchronization raster 0 indicates a CORESET 0 and search space 0 used for the SIB1 1112 delivery. The SIB1 1112 transmitted in the initial BWP 0 indicates CORESET 1 and search space 1 used for the extended SIB1 1106 delivery in the initial BWP 1 and CORESET 2 and search space 2 used for the extended SIB1 1108 delivery in the initial BWP 2. For example, if a UE 104 detects the SSB 1102 of the cell (including successful decoding of a PBCH corresponding to the SSB 1102) on the synchronization raster 1 and the cell is not barred, the UE 104 may retune a LO to receive the SSB 1110 on the synchronization raster 0. If the UE 104 detects the SSB 1110 of the cell (including successful decoding of a corresponding PBCH) on the synchronization raster 0, the UE 104 receives SIB1 1112 of the cell. If the UE 104 determines to camp on the initial BWP 2 of the cell, the UE 104 may retune the LO to operate in the initial BWP 2, acquire the extended SIB1 1108 for the initial BWP 2, and use common parameters configured in the extended SIB1 1108 of the initial BWP 2 for performing communications in the initial BWP 2.

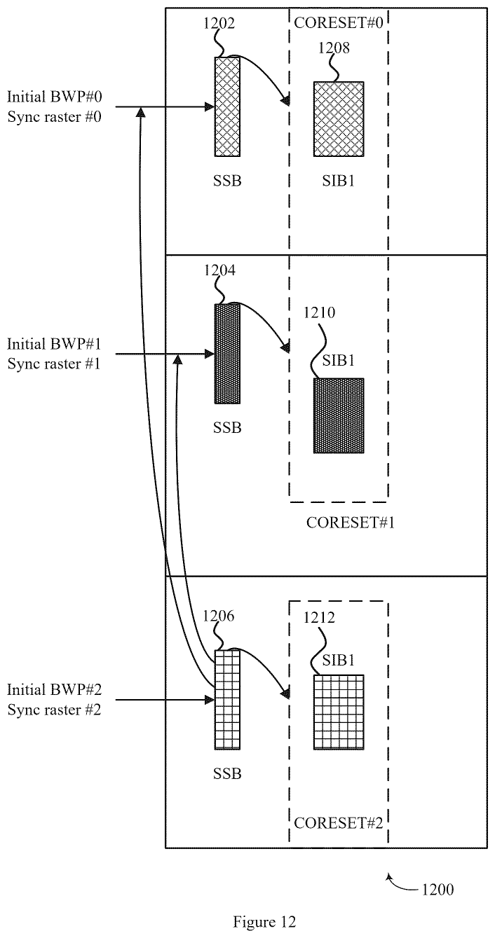

FIG. 12 illustrates an example 1200 of operations with multiple initial BWPs in a cell in accordance with aspects of the present disclosure. The example 1200 reduces on-time of a network entity regarding initial access related signaling and broadcast signal/channel transmission. In multiple beam-based cell operation, a SSB on a synchronization raster entry is replaced with a SSB burst, e.g., a set of SSBs on the synchronization raster entry.

In the example 1200, SSBs 1202, 1204, and 1206 of a cell on synchronization raster 0, 1, and 2 have corresponding SIB1 1208, 1210, and 1212 in corresponding initial BWP 0, 1, and 2, respectively. Each SSB 1202, 1204, and 1206 of the cell (including a corresponding PBCH) on a different synchronization raster entry indicates a corresponding CORESET and a corresponding search space for delivery of a corresponding SIB1 1208, 1210, and 1212 of the cell. Further, each SSB 1202, 1204, and 1206 of the cell (including the corresponding PBCH) indicates other synchronization raster entries of the cell. For example, the SSB 1206 on synchronization raster 2 indicates the synchronization raster 0 and 1. Each SIB1 1208, 1210, and 1212 in each initial BWP contains configuration of common parameters of the corresponding initial BWP. If a UE 104 detects the SSB 1204 of the cell (including successful decoding of a PBCH corresponding to the SSB 1204) on the synchronization raster 1, if the cell is not barred, and if the UE 104 determines to camp on the initial BWP 2 of the cell, the UE 104 may retune the LO to operate in the initial BWP 2, acquire the SIB1 1212 for the initial BWP 2, and use common parameters configured in the SIB1 1212 of the initial BWP 2 for operating in the initial BWP 2.

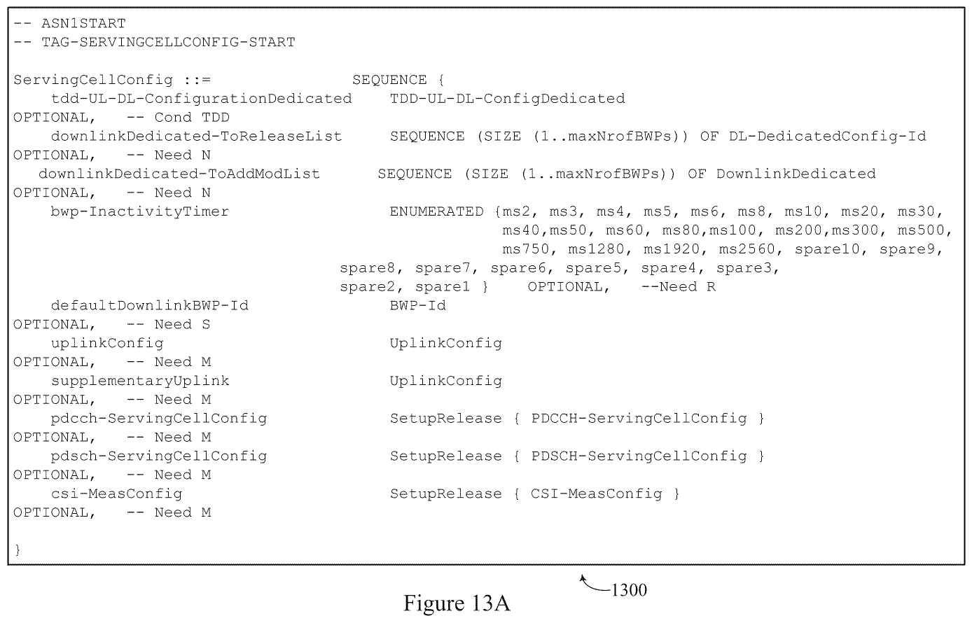

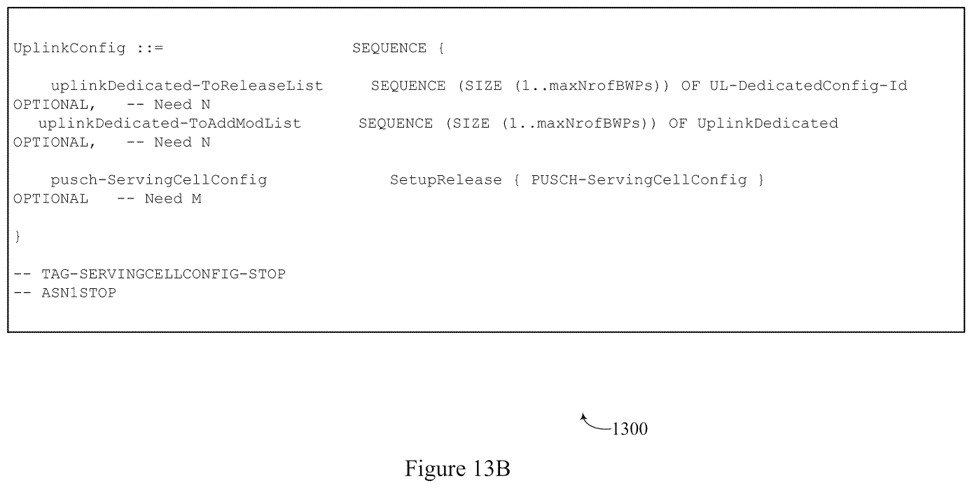

Returning to FIG. 2, UE-specific parameters are configured for a cell-specific BWP. In one or more implementations, a UE 104 receives a first set of cell-wise (e.g., cell-specific) BWP configurations for reception, e.g., a set of DL BWPs, and a second set of cell-wise BWP configurations for transmission, e.g., a set of UL BWPs, where each cell-wise BWP configuration includes at least a location in a frequency domain, a bandwidth, a SCS, and a CP of a BWP and a BWP index in the set of DL BWPs or in the set of UL BWPs. The set of DL BWP configurations and the set of UL BWP configurations are included in an IE of a system information block (SIB), e.g., Serving CellConfigCommonSIB shown in SIB IE 400 of FIG. 4, and/or in an IE including common parameters of a serving cell in a dedicated radio resource configuration (RRC) message, e.g., ServingCellConfigCommon. Further, the UE 104 receives a list of BWP-specific dedicated configurations, where each configuration configures a set of dedicated (UE-specific) parameters, which can be associated with one or multiple cell-specific BWP(s). The list of BWP-specific dedicated configurations is included in an IE including dedicated parameters of a serving cell in a dedicated RRC message. The list of BWP-specific dedicated configurations is included in an IE including dedicated parameters of a serving cell in a dedicated RRC message, such as a ServingCellConfig IE discussed below with reference to FIGS. 13A and 13B. The UE 104 identifies association between a set of dedicated parameters in a configuration and one or multiple cell-specific BWP(s) based on implicit or explicit indication in the configuration and applies the set of dedicated parameters to the corresponding one or multiple cell-specific BWP(s) based on identification. For example, a BWP-specific dedicated DL configuration includes a list of DL BWP identities (IDs) associated with the BWP-specific dedicated DL configuration. When more than one BWP use a same set of dedicated parameters, providing the set of dedicated parameters once with an indication of associated BWP IDs reduces signaling overhead compared to including the same set of dedicated parameters in each BWP configuration.

In one or more implementations, a cell-wise BWP configuration further includes an indication of a communication direction, for example, ‘downlink’, ‘uplink’, and ‘both’ (e.g., both downlink and uplink). If a BWP configuration includes a communication direction indicator field set to ‘both’ and if the BWP configuration is included in a list of DL BWP configuration, the BWP configuration is not included in a list of UL BWP configuration, but a UE 104 assumes that the BWP configuration is also an UL BWP configuration. When a given frequency resource (e.g., a BWP) is used with the same SCS and the same CP for both uplink and downlink with time division duplexing (TDD) in unpaired spectrum and/or with sub-band full duplex, signaling the BWP configuration once for both downlink and uplink would reduce signaling overhead.

FIGS. 13A, 13B, 14, and 15 illustrate examples to configure dedicated parameters in one or more cell-specific BWPs.

FIGS. 13A and 13B illustrate an example of a configuration IE 1300 in accordance with aspects of the present disclosure. The configuration IE 1300 is a ServingCellConfig IE that is used to configure (add or modify) a UE with UE-specific parameters of a serving cell. A list of BWP-specific dedicated configurations can be in an IE, such as IE 1300, including dedicated parameters of a serving cell in a dedicated RRC message.

The configuration IE 1300 includes a bwp-InactivityTimer field that indicates the duration in ms after which the UE falls back to the default BWP. When the network releases the timer configuration, the UE stops the timer without switching to the default BWP. The configuration IE 1300 also includes a defaultDownlinkBWP-Id field that indicates an ID of the downlink BWPto be used upon expiry of the BWP inactivity timer. When the field is absent the UE uses the initial BWP as default BWP. The configuration IE 1300 also includes a downlinkDedicated-ToAddModList, uplinkDedicated-ToAddModList field that indicates a list of BWP-specific dedicated configurations to be added or modified.

The configuration IE 1300 also includes a downlinkDedicated-ToReleaseList, uplinkDedicated-ToReleaseList field that indicates a list of BWP-specific dedicated configurations to be released. The configuration IE 1300 also includes a pdcch-ServingCellConfig, pdsch-ServingCellConfig, csi-MeasConfig, pusch-ServingCellConfig field that indicates PDCCH, PDSCH, CSI measurement, and PUSCH related parameters, respectively, that are not BWP-specific. The configuration IE 1300 also includes a supplementarylJplink field, where the network may configure this field only when supplementarylJplinkCommon is configured in Serving CellConfigCommon or in ServingCellConfigCommonSIB. The configuration IE 1300 also includes a uplinkConfig field, where the network may configure this field only when uplinkConfigCommon is configured in ServingCellConfigCommon or ServingCellConfigCommonSIB.

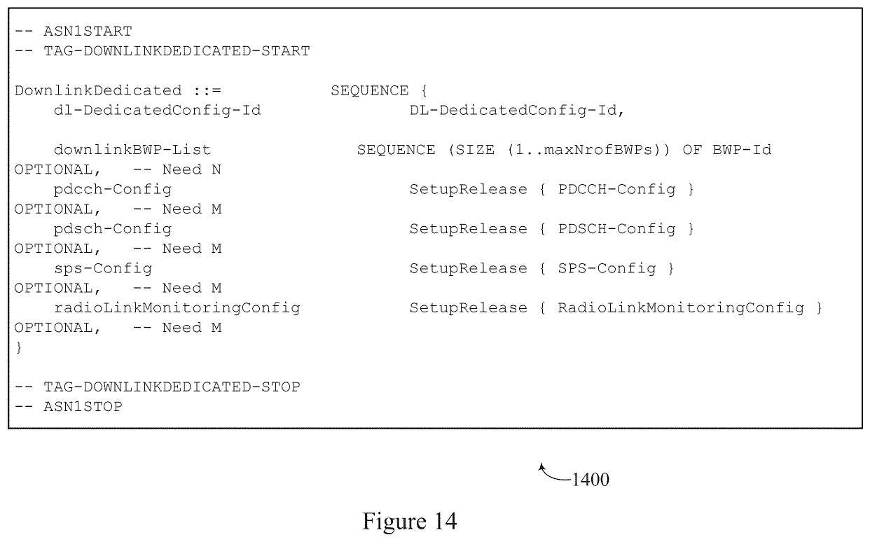

FIG. 14 illustrates an example of a configuration IE 1400 in accordance with aspects of the present disclosure. The configuration IE 1400 is a DownlinkDedicated IE that is used to configure a set of dedicated (UE specific) parameters, which can be associated with one or multiple cell-specific downlink BWP(s). The configuration IE 1400 includes a dl-DedicatedConfig-ID field that indicates an identifier for this BWP-specific dedicated downlink configuration. The configuration IE 1400 also includes a downlinkBWP-List field that identifies a list of DL BWPs associated with this BWP-specific dedicated downlink configuration.

The configuration IE 1400 also includes a pdcch-Config field that indicates UE-specific PDCCH configuration for associated one or multiple DL BWP(s). The configuration IE 1400 also includes a pdsch-Config field that indicates UE-specific PDSCH configuration for associated one or multiple DL BWP(s). The configuration IE 1400 also includes a sps-Config field that indicates UE specific SPS configuration for associated one or multiple DL BWP(s). Except for reconfiguration with sync, the NW does not reconfigure sps-Config when there is an active configured downlink assignment. However, the NW may release the sps-Config at any time. The configuration IE 1400 also includes a radioLinkMonitoringConfig field that indicates UE specific configuration of radio link monitoring for detecting cell- and beam radio link failure occasions. The maximum number of failure detection resources should be limited up to 8 for both cell and beam radio link failure detection.

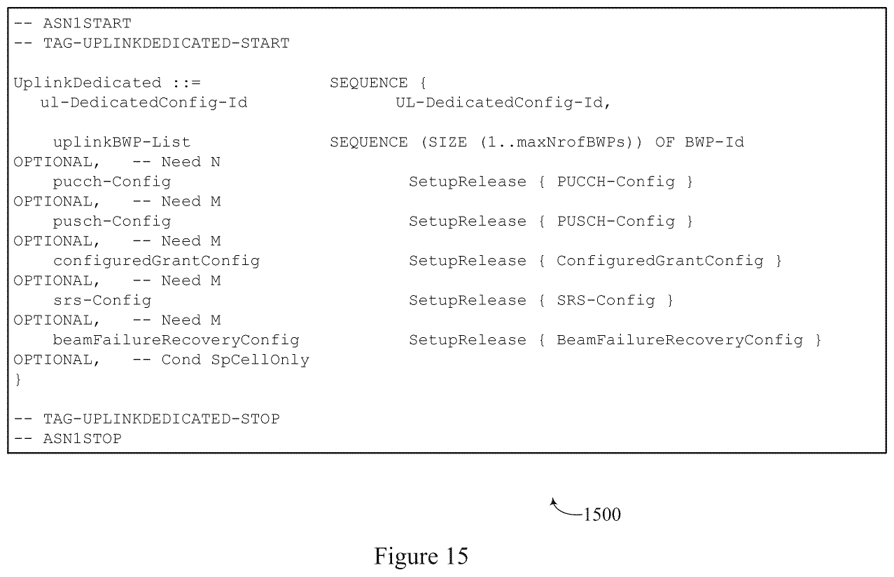

FIG. 15 illustrates an example of a configuration IE 1500 in accordance with aspects of the present disclosure. The configuration IE 1500 is an UplinkDedicated IE that is used to configure dedicated (UE specific) parameters, which can be associated with one or multiple uplink BWP(s).

The configuration IE 1500 includes a ul-DedicatedConfig-Id field that indicates an identifier for this BWP-specific dedicated uplink configuration. The configuration IE 1500 also includes a uplinkBWP-List field that identifies a list of UL BWPs associated with this BWP-specific dedicated uplink configuration. The configuration IE 1500 also includes a beamFailureRecoveryConfig field that indicates configuration of beam failure recovery. If supplementarylJplink is present, the field is present only in one of the uplink carriers, either UL or supplementary uplink (SUL).

The configuration IE 1500 also includes a configuredGrantConfig field that indicates a Configured-Grant of type1 or type2. It may be configured for UL or SUL but in case of type1 not for both at a time. Except for reconfiguration with sync, the NW does not reconfigure configuredGrantConfig when there is an active configured uplink grant Type 2. However, the NW may release the configuredGrantConfig at any time.

The configuration IE 1500 also includes a pucch-Config field that indicates PUCCH configuration for one or multiple BWP(s) of the normal UL or SUL of a serving cell. If the UE is configured with SUL, the network configures PUCCH only on one of the uplinks (normal UL or SUL). The configuration IE 1500 also includes a pusch-Config field that indicates

PUSCH configuration for one or multiple BWP(s) of the normal UL or SUL of a serving cell. If the UE is configured with SUL and if it has a PUSCH-Config for both UL and SUL, an UL/SUL indicator field in DCI indicates which of the two to use. The configuration IE 1500 also includes a srs-Config field that indicates UL sounding reference signal configuration.

Returning to FIG. 2, with respect to paging in a wideband carrier, in one or more implementations a UE 104 receives an indication of a plurality of initial BWPs of a cell, selects an initial BWP from the plurality of initial BWPs at least based on a UE identity, and monitor paging DCI in the selected initial BWP of the cell.

In one example, if a UE 104 detects a SSB of a cell (including successful decoding of a PBCH corresponding to the SSB) on a first synchronization raster entry and if the UE 104 determines at least based on an indication of the SSB that the cell is not barred and the SSB of the cell on the first synchronization raster entry has an associated SIB1 of the cell in a first initial BWP associated with the first synchronization raster entry, the UE 104 receives an indication of a plurality of initial BWPs by receiving the SIB1 in the first initial BWP. If the UE 104 determines to camp on a second initial BWP from the plurality of initial BWPs at least based on a UE identity, the UE 104 acquires an extended SIB1 in the second initial BWP and uses common parameters configured in the extended SIB1 of the second initial BWP for monitoring paging DCI in the second initial BWP. The UE 104 may retune its LO to operate in the second initial BWP.

In another example, if a UE 104 detects a SSB of a cell (including successful decoding of a PBCH corresponding to the SSB) on a first synchronization raster entry and if the UE 104 determines at least based on an indication of the SSB that the cell is not barred, the SSB of the cell on the first synchronization raster entry is associated with an extended SIB1 of the cell in a first initial BWP associated with the first synchronization raster entry, and a SIB1 of the cell is transmitted in a second initial BWP associated with a second synchronization raster entry, the UE 104 detects a SSB on the second synchronization raster entry and receives the SIB1 of the cell in the second initial BWP. The UE 104 may retune a LO to operate in the second initial BWP. Upon receiving the SIB1, the UE 104 identifies a plurality of initial BWPs of the cell, determines to camp on a third initial BWP of the cell at least based on a UE identity, and monitors paging DCI in the third initial BWP of the cell.

In one or more implementations, a UE 104 receives an indication of a plurality of synchronization raster entries of a cell, where each synchronization raster entry is associated with an initial BWP of a plurality of initial BWPs of the cell, selects a synchronization raster entry of the cell from the plurality of synchronization raster entries of the cell at least based on a UE identity, determines parameters for an initial BWP of the cell associated with the selected synchronization raster entry of the cell, and monitors paging DCI based on the determined parameters in the initial BWP of the cell.

In one example, if a UE 104 detects a SSB of a cell (including successful decoding of a PBCH corresponding to the SSB) on a first synchronization raster entry, if the cell is not barred, if the UE 104 receives an indication of a plurality of synchronization raster entries of the cell via detection and decoding of the SSB on the first synchronization raster entry, and if the UE 104 selects a second synchronization raster entry of the cell based on a UE identity, the UE 104 detects a SSB of the cell on the second synchronization raster entry of the cell. The UE 104 may retune the LO to detect the SSB of the cell on the second synchronization raster entry. Upon successful detection of the SSB of the cell on the second synchronization raster entry, the UE 104 receives a SIB1 in an initial BWP associated with the second synchronization raster entry and determines parameters for the initial BWP at least based on the received SIB1. The UE 104 monitors paging DCI in the initial BWP based on the determined parameters for the initial BWP.

A UE 104 may use DRX in RRC_IDLE and RRC_INACTIVE state in order to reduce power consumption. The UE 104 monitors one PO per DRX cycle. A PO is a set of PDCCH monitoring occasions and can consist of multiple time slots (e.g., subframe or OFDM symbol) where paging DCI can be sent. One PF is one radio frame and may contain one or multiple PO(s) or starting point of a PO.

In one or more implementations, an initial BWP, a PF, and, a PO for a UE 104 is determined based on an identifier of the UE (UE_ID) and can be determined in any of a variety of manners, such as any of a variety of techniques or formulas that distribute the UEs 104 communicating with the cell approximately evenly across the initial BWPs, PFs, and/or POs of the cell.

In one example, an initial BWP, a PF, and, a PO for a UE 104 are determined as follows. The following parameters are used for the calculation of b, PF, and i_s: T refers to a DRX cycle of the UE 104; B refers to a number of total initial BWPs in a cell; N refers to a number of total paging frames in T per initial BWP; Ns refers to a number of paging occasions for a PF per initial BWP; PF_offset refers to an offset used for PF determination; and UE_ID refers to a 5G-S temporary mobile subscriber identity (5G-S-TMSI) mod 1024. “Floor” refers to rounding a number down to the nearest integer. An initial BWP index b is determined by:

$$b = floor ( UE\_ID / B ) mod B .$$

An SFN for the PF in the initial BWP b is determined by:

$$( SFN + PF\_offset ) mod T = ( T div N ) * ( ( floor ( ( UE\_ID - B \times b ) / B ) + UE\_ID mod B ) mod N ) .$$

Index (i_s), indicating the index of the PO in the initial BWP b is determined by:

$$i\_s = floor ( ( floor ( ( UE\_ID - B \times b ) / B ) + {UE}_{-} ID mod B ) / N ) mod Ns .$$

Parameters Ns, nAndPagingFrameOffset, and the length of default DRX Cycle are signaled in SIB1. The values of N and PF_offset are derived from the parameter nAndPagingFrameOffset as defined in SIB IE 500 of FIGS. 5A and 5B discussed above. The parameter firstPDCCH-MonitoringOccasionOfPO is signaled in SIB1.

In one example, if the UE 104 has no 5G-S-TMSI, for instance when the UE 104 has not yet registered onto the network, the UE 104 uses a default identity UE_ID=0 in the formulas above.

In one example, 5G-S-TMSI is a 48 bit long bit string and is interpreted as a binary number where the left most bit represents the most significant bit.

Table 5 shows an example mapping of UE IDs of 0-51 to an initial BWP, a PF, and a PO according to the formula above, when B=3, N=4, Ns=4, and PS_offset=0.

TABLE 5

| | PF (SFN = 0) | | | | PF (SFN = 8) | | | | PF (SFN = 16) | | | | PF (SFN = 24) | | | |
|---|---|---|---|---|---|---|---|---|---|---|---|---|---|---|---|---|
| | PO | PO | PO | PO | PO | PO | PO | PO | PO | PO | PO | PO | PO | PO | PO | PO |
| | #0 | #1 | #2 | #3 | #0 | #1 | #2 | #3 | #0 | #1 | #2 | #3 | #0 | #1 | #2 | #3 |
| BWP 0 | 0.46 | 10 | 20 | 36 | 1.47 | 11 | 27 | 37 | 2 | 18 | 28 | 38 | 9 | 19 | 29 | 45 |
| BWP 1 | 3.49 | 13 | 23 | 39 | 4.50 | 14 | 30 | 40 | 5 | 21 | 31 | 41 | 12 | 22 | 32 | 48 |
| BWP 2 | 6 | 16 | 26 | 42 | 7 | 17 | 33 | 43 | 8 | 24 | 34 | 44 | 15 | 25 | 35 | 51 |

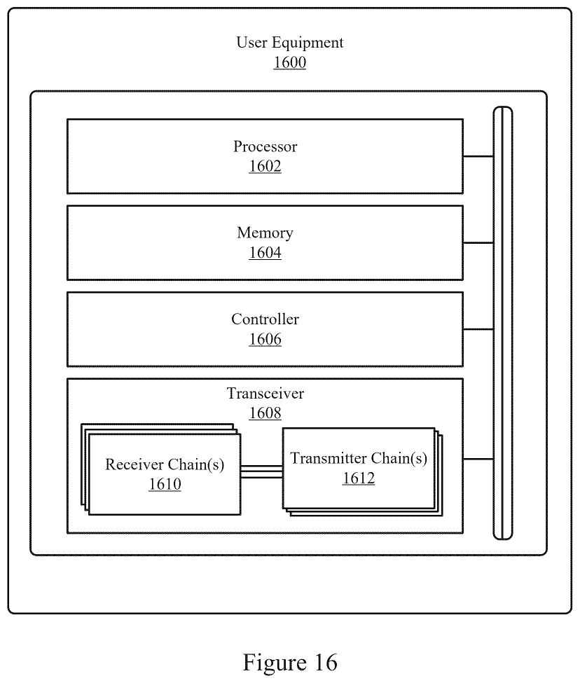

FIG. 16 illustrates an example of a UE 1600 in accordance with aspects of the present disclosure. The UE 1600 may include a processor 1602, a memory 1604, a controller 1606, and a transceiver 1608. The processor 1602, the memory 1604, the controller 1606, or the transceiver 1608, or various combinations thereof or various components thereof may be examples of means for performing various aspects of the present disclosure as described herein. These components may be coupled (e.g., operatively, communicatively, functionally, electronically, electrically) via one or more interfaces.

The processor 1602, the memory 1604, the controller 1606, or the transceiver 1608, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 1602 may include an intelligent hardware device (e.g., a general-purpose processor, a DSP, a CPU, an ASIC, an FPGA, or any combination thereof). In some implementations, the processor 1602 may be configured to operate the memory 1604. In some other implementations, the memory 1604 may be integrated into the processor 1602. The processor 1602 may be configured to execute computer-readable instructions stored in the memory 1604 to cause the UE 1600 to perform various functions of the present disclosure.

The memory 1604 may include volatile or non-volatile memory. The memory 1604 may store computer-readable, computer-executable code including instructions when executed by the processor 1602 cause the UE 1600 to perform various functions described herein. The code may be stored in a non-transitory computer-readable medium such as the memory 1604 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 1602 and the memory 1604 coupled with the processor 1602 may be configured to cause the UE 1600 to perform one or more of the functions described herein (e.g., executing, by the processor 1602, instructions stored in the memory 1604). For example, the processor 1602 may support wireless communication at the UE 1600 in accordance with examples as disclosed herein. The UE 1600 may be configured to or operable to support a means for receiving a first signaling indicating a first SSB of a cell on a first synchronization raster entry; decoding a first PBCH associated with the first SSB; identifying a second synchronization raster entry of the cell based at least in part on the first PBCH, where the second synchronization raster entry is different from the first synchronization raster entry, and where each of the first synchronization raster entry and the second synchronization raster entry is associated with a different initial BWP of a plurality of initial BWPs of the cell; and camping on an initial BWP of the plurality of initial BWPs of the cell.

Additionally, the UE 1600 may be configured to support any one or combination of receiving a second signaling indicating a SIB1 of the cell, where the SIB1 is associated with the first SSB, where the second synchronization raster entry of the cell is identified based on the first PBCH and the SIB1, and where the SIB1 includes information describing the plurality of initial BWPs of the cell; selecting the initial BWP of the plurality of initial BWPs, where the information describing the plurality of initial BWPs of the cell includes association information between each of the plurality of initial BWPs and one of a plurality of synchronization raster entries of the cell, the plurality of synchronization raster entries including the first synchronization raster entry and the second synchronization raster entry, where the second synchronization raster entry of the cell is identified based at least in part on selection of the initial BWP and the association information between the initial BWP and the second synchronization raster entry, and where the initial BWP is associated with the second synchronization raster entry; where for at least one initial BWP of the cell, the information describing the plurality of initial BWPs of the cell in the SIB1 includes a CORESET and a PDCCH search space for monitoring an extended SIB1 in the initial BWP of the cell; where the extended SIB1 transmitted in the initial BWP includes common parameters for the initial BWP; receiving a third signaling indicating a second SSB of the cell on a third synchronization raster entry; determining whether the second SSB has an associated SIB1 of the cell; identifying the first synchronization raster entry of the cell in response to determining that the second SSB does not have an associated SIB1 of the cell, where the first signaling indicating the first SSB is received upon identification of the first synchronization raster entry of the cell; decoding a second PBCH associated with the second SSB, where identification of the first synchronization raster entry of the cell is based at least in part on the second PBCH; where the first PBCH indicates one or more additional synchronization raster entries of a plurality of synchronization raster entries of the cell, and where each of the plurality of synchronization raster entries is associated with a different initial BWP of the plurality of initial BWPs of the cell; selecting the second synchronization raster entry of the plurality of synchronization raster entries of the cell; receiving a second signaling indicating a second SSB of the cell on the second synchronization raster entry of the cell; and receiving a third signaling indicating a SIB1 of the cell, where the SIB1 is associated with the second SSB, where camping on the initial BWP is based at least in part on the second SSB and the SIB1 associated with the second SSB; selecting the first synchronization raster entry of the plurality of synchronization raster entries of the cell; and receiving a second signaling indicating a SIB1 of the cell, where the SIB1 is associated with the first SSB, and where camping on the initial BWP is based at least in part on the first SSB and the SIB1 associated with the first SSB; receiving a second signaling indicating a SIB1 of the cell, where the SIB1 includes layer 2 and layer 3 configuration information for the cell; receiving a second signaling indicating a number of initial BWPs in the plurality of initial BWPs of the cell; receiving a second signaling indicating a plurality of cell-specific BWP configurations of the cell; receiving a third signaling indicating a plurality of UE-specific BWP configurations of the cell; receiving association information between each of the plurality of cell-specific BWP configurations and one of the plurality of UE-specific BWP configurations; and using a cell-specific BWP configuration of the plurality of cell-specific BWP configurations and a UE-specific BWP configuration of the plurality of UE-specific BWP configurations for communication in a BWP, where the UE-specific BWP configuration is associated with the cell-specific BWP configuration and is identified based on the association information.

Additionally, or alternatively, the UE 1600 may support at least one memory (e.g., the memory 1604) and at least one processor (e.g., the processor 1602) coupled with the at least one memory and configured to cause the UE to: receive a first signaling indicating a first SSB of a cell on a first synchronization raster entry; decode a first PBCH associated with the first SSB; identify a second synchronization raster entry of the cell based at least in part on the first PBCH, where the second synchronization raster entry is different from the first synchronization raster entry, and where each of the first synchronization raster entry and the second synchronization raster entry is associated with a different initial BWP of a plurality of initial BWPs of the cell; and camp on an initial BWP of the plurality of initial BWPs of the cell.

Additionally, the UE 1600 may be configured to support any one or combination of the at least one processor is configured to receive a second signaling indicating a SIB1 of the cell, where the SIB1 is associated with the first SSB, where the second synchronization raster entry of the cell is identified based on the first PBCH and the SIB1, and where the SIB1 includes information describing the plurality of initial BWPs of the cell: select the initial BWP of the plurality of initial BWPs, where the information describing the plurality of initial BWPs of the cell includes association information between each of the plurality of initial BWPs and one of a plurality of synchronization raster entries of the cell, the plurality of synchronization raster entries including the first synchronization raster entry and the second synchronization raster entry, where the second synchronization raster entry of the cell is identified based at least in part on selection of the initial BWP and the association information between the initial BWP and the second synchronization raster entry, and where the initial BWP is associated with the second synchronization raster entry; where for at least one initial BWP of the cell, the information describing the plurality of initial BWPs of the cell in the SIB1 includes a CORESET and a PDCCH search space for monitoring an extended SIB1 in the initial BWP of the cell; where the extended SIB1 transmitted in the initial BWP includes common parameters for the initial BWP; receive a third signaling indicating a second SSB of the cell on a third synchronization raster entry; determine whether the second SSB has an associated SIB1 of the cell; identify the first synchronization raster entry of the cell in response to determining that the second SSB does not have an associated SIB1 of the cell, where the first signaling indicating the first SSB is received upon identification of the first synchronization raster entry of the cell; decode a second PBCH associated with the second SSB, where identification of the first synchronization raster entry of the cell is based at least in part on the second PBCH; where the first PBCH indicates one or more additional synchronization raster entries of a plurality of synchronization raster entries of the cell, and where each of the plurality of synchronization raster entries is associated with a different initial BWP of the plurality of initial BWPs of the cell; select the second synchronization raster entry of the plurality of synchronization raster entries of the cell; receive a second signaling indicating a second SSB of the cell on the second synchronization raster entry of the cell; and receive a third signaling indicating a SIB1 of the cell, where the SIB1 is associated with the second SSB, where camping on the initial BWP is based at least in part on the second SSB and the SIB1 associated with the second SSB; select the first synchronization raster entry of the plurality of synchronization raster entries of the cell; and receive a second signaling indicating a SIB1 of the cell, where the SIB1 is associated with the first SSB, and where camping on the initial BWP is based at least in part on the first SSB and the SIB1 associated with the first SSB; receive a second signaling indicating a SIB1 of the cell, where the SIB1 includes layer 2 and layer 3 configuration information for the cell; receive a second signaling indicating a number of initial BWPs in the plurality of initial BWPs of the cell; receive a second signaling indicating a plurality of cell-specific BWP configurations of the cell; receive a third signaling indicating a plurality of UE-specific BWP configurations of the cell; receive association information between each of the plurality of cell-specific BWP configurations and one of the plurality of UE-specific BWP configurations; and use a cell-specific BWP configuration of the plurality of cell-specific BWP configurations and a UE-specific BWP configuration of the plurality of UE-specific BWP configurations for communication in a BWP, where the UE-specific BWP configuration is associated with the cell-specific BWP configuration and is identified based on the association information.

In some implementations, the processor 1602 and the memory 1604 coupled with the processor 1602 may be configured to cause the UE 1600 to perform one or more of the functions described herein (e.g., executing, by the processor 1602, instructions stored in the memory 1604). For example, the processor 1602 may support wireless communication at the UE 1600 in accordance with examples as disclosed herein. The UE 1600 may be configured to or operable to support a means for receiving a first signaling indicating a plurality of initial BWP of a cell; selecting, based at least in part on an ID of the UE, an initial BWP from the plurality of initial BWPs; and monitoring paging DCI in the selected initial BWP of the cell.

Additionally, the UE 1600 may be configured to support any one or combination of detecting a SSB of the cell on a first synchronization raster entry; decoding a PBCH associated with the SSB; and determining, based at least in part on the PBCH, that the cell is not barred and that the SSB has an associated SIB1 of the cell in a first initial BWP associated with the first synchronization raster entry, where to receive the first signaling is to receive the SIB1 in the first initial BWP, and where the SIB1 includes the indication of the plurality of initial BWPs; acquiring an extended SIB1 in the second initial BWP; and using parameters configured in the extended SIB1 of the second initial BWP for monitoring the paging DCI in the second initial BWP; detecting a first SSB of a cell on a first synchronization raster entry; decoding a PBCH associated with the first SSB; determining, based at least in part on the PBCH, that the cell is not barred, that the first SSB is associated with an extended SIB1 of the cell in a first initial BWP associated with the first synchronization raster entry, and that a SIB1 of the cell is transmitted in a second initial BWP associated with a second synchronization raster entry; detecting a second SSB of the cell on the second synchronization raster entry; and receiving the SIB1 of the cell in the second initial BWP, where to receive the first signaling is to receive the SIB1 in the second initial BWP, and where the SIB1 includes the indication of the plurality of initial BWPs; where selecting the initial BWP includes selecting the initial BWP based at least in part on the ID of the UE and at least one of a DRX cycle of the UE, a number of initial BWPs in the plurality of initial BWPs, a number of total paging frames in the DRX cycle of the UE per initial BWP, and a number of paging occasions for a PF per initial BWP; determining a PF of the UE based at least in part on the ID of the UE, an index of the selected initial BWP, a DRX cycle of the UE, a number of initial BWPs in the plurality of initial BWPs, and a number of total paging frames in the DRX cycle of the UE per initial BWP; and determining a paging occasion of the UE based at least in part on the ID of the UE, the index of the selected initial BWP, the number of initial BWPs in the plurality of initial BWPs, the number of total paging frames in the DRX cycle of the UE per initial BWP, and a number of paging occasions for a PF per initial BWP.

In some implementations, the processor 1602 and the memory 1604 coupled with the processor 1602 may be configured to cause the UE 1600 to perform one or more of the functions described herein (e.g., executing, by the processor 1602, instructions stored in the memory 1604). For example, the processor 1602 may support wireless communication at the UE 1600 in accordance with examples as disclosed herein. The UE 1600 may be configured to or operable to support a means for receiving a first signaling indicating a plurality of synchronization raster entries of a cell, where each of the plurality of synchronization raster entries is associated with a distinctive initial BWP of a plurality of initial BWPs of the cell; selecting, based at least in part on an ID of the UE, a synchronization raster entry from the plurality of synchronization raster entries; determining one or more parameters for an initial BWP of the cell associated with the selected synchronization raster entry; monitoring paging DCI based at least in part on the determined parameters for the initial BWP of the cell.

Additionally, the UE 1600 may be configured to support any one or combination of detecting a SSB of the cell on the selected synchronization raster entry; decoding a PBCH associated with the SSB; determining, based at least in part on the PBCH, that the cell is not barred and that the SSB has an associated SIB1 of the cell, where the first signaling is received at least in part in the PBCH; and receiving the SIB1 in the initial BWP associated with the selected synchronization raster entry upon selection of the synchronization raster entry, where the SIB1 includes the one or more parameters for the initial BWP; detecting a first SSB of the cell on a first synchronization raster entry of the plurality of synchronization raster entries of the cell, where the selected synchronization raster entry is a second synchronization raster entry, and where the first synchronization raster entry is different from the second synchronization raster entry; decoding a PBCH associated with the first SSB; determining, based at least in part on the PBCH, that the cell is not barred and that the first SSB has an associated SIB1 of the cell in a first initial BWP associated with the first synchronization raster entry, where the first signaling is received at least in part in the PBCH; detecting a second SSB of the cell on the second synchronization raster entry upon selection of the second synchronization raster entry; and receiving a SIB1 of the cell in a second initial BWP associated with the second synchronization raster entry, where the SIB1 includes the one or more parameters for the second initial BWP; where selecting the synchronization raster entry includes selecting the synchronization raster entry based at least in part on the ID of the UE and at least one of a DRX cycle of the UE, a number of initial BWPs in the plurality of initial BWPs, a number of total paging frames in the DRX cycle of the UE per initial BWP, and a number of paging occasions for a PF per initial BWP; determining a PF of the UE based at least in part on the ID of the UE, an index of the initial BWP, a DRX cycle of the UE, a number of initial BWPs in the plurality of initial BWPs, and a number of total paging frames in the DRX cycle of the UE per initial BWP; and determining a paging occasion of the UE based at least in part on the ID of the UE, the index of the initial BWP, the number of initial BWPs in the plurality of initial BWPs, the number of total paging frames in the DRX cycle of the UE per initial BWP, and a number of paging occasions for a PF per initial BWP.

Additionally, or alternatively, the UE 1600 may support at least one memory (e.g., the memory 1604) and at least one processor (e.g., the processor 1602) coupled with the at least one memory and configured to cause the UE to: receive a first signaling indicating a plurality of initial BWP of a cell; select, based at least in part on an ID of the UE, an initial BWP from the plurality of initial BWPs; monitor paging DCI in the selected initial BWP of the cell.

Additionally, the UE 1600 may be configured to support any one or combination of the at least one processor is configured to cause the UE to detect a SSB of the cell on a first synchronization raster entry; decode a PBCH associated with the SSB; and determine, based at least in part on the PBCH, that the cell is not barred and that the SSB has an associated SIB1 of the cell in a first initial BWP associated with the first synchronization raster entry, where to receive the first signaling is to receive the SIB1 in the first initial BWP, and where the SIB1 includes the indication of the plurality of initial BWPs; where the selected initial BWP includes a second initial BWP; acquire an extended SIB1 in the second initial BWP; and use parameters configured in the extended SIB1 of the second initial BWP for monitoring the paging DCI in the second initial BWP; detect a first SSB of a cell on a first synchronization raster entry; decode a PBCH associated with the first SSB; determine, based at least in part on the PBCH, that the cell is not barred, that the first SSB is associated with an extended SIB1 of the cell in a first initial BWP associated with the first synchronization raster entry, and that a SIB1 of the cell is transmitted in a second initial BWP associated with a second synchronization raster entry; detect a second SSB of the cell on the second synchronization raster entry; and receive the SIB1 of the cell in the second initial BWP, where to receive the first signaling is to receive the SIB1 in the second initial BWP, and where the SIB1 includes the indication of the plurality of initial BWPs; where to select the initial BWP is to select the initial BWP based at least in part on the ID of the UE and at least one of a DRX cycle of the UE, a number of initial BWPs in the plurality of initial BWPs, a number of total paging frames in the DRX cycle of the UE per initial BWP, and a number of paging occasions for a PF per initial BWP; determine a PF of the UE based at least in part on the ID of the UE, an index of the selected initial BWP, a DRX cycle of the UE, a number of initial BWPs in the plurality of initial BWPs, and a number of total paging frames in the DRX cycle of the UE per initial BWP; and determine a paging occasion of the UE based at least in part on the ID of the UE, the index of the selected initial BWP, the number of initial BWPs in the plurality of initial BWPs, the number of total paging frames in the DRX cycle of the UE per initial BWP, and a number of paging occasions for a PF per initial BWP.

Additionally, or alternatively, the UE 1600 may support at least one memory (e.g., the memory 1604) and at least one processor (e.g., the processor 1602) coupled with the at least one memory and configured to cause the UE to: receive a first signaling indicating a plurality of synchronization raster entries of a cell, where each of the plurality of synchronization raster entries is associated with a distinctive initial BWP of a plurality of initial BWPs of the cell; select, based at least in part on an ID of the UE, a synchronization raster entry from the plurality of synchronization raster entries; determine one or more parameters for an initial BWP of the cell associated with the selected synchronization raster entry; monitor paging DCI based at least in part on the determined parameters for the initial BWP of the cell.

Additionally, the UE 1600 may be configured to support any one or combination of the at least one processor is configured to cause the UE to detect a SSB of the cell on the selected synchronization raster entry; decode a PBCH associated with the SSB; determine, based at least in part on the PBCH, that the cell is not barred and that the SSB has an associated SIB1 of the cell, where the first signaling is received at least in part in the PBCH; and receive the SIB1 in the initial BWP associated with the selected synchronization raster entry upon selection of the synchronization raster entry, where the SIB1 includes the one or more parameters for the initial BWP; detect a first SSB of the cell on a first synchronization raster entry of the plurality of synchronization raster entries of the cell, where the selected synchronization raster entry is a second synchronization raster entry, and where the first synchronization raster entry is different from the second synchronization raster entry; decode a PBCH associated with the first SSB; determine, based at least in part on the PBCH, that the cell is not barred and that the first SSB has an associated SIB1 of the cell in a first initial BWP associated with the first synchronization raster entry, where the first signaling is received at least in part in the PBCH; detect a second SSB of the cell on the second synchronization raster entry upon selection of the second synchronization raster entry; and receive a SIB1 of the cell in a second initial BWP associated with the second synchronization raster entry, where the SIB1 includes the one or more parameters for the second initial BWP; where to select the synchronization raster entry is to select the synchronization raster entry based at least in part on the ID of the UE and at least one of a DRX cycle of the UE, a number of initial BWPs in the plurality of initial BWPs, a number of total paging frames in the DRX cycle of the UE per initial BWP, and a number of paging occasions for a PF per initial BWP; determine a PF of the UE based at least in part on the ID of the UE, an index of the initial BWP, a DRX cycle of the UE, a number of initial BWPs in the plurality of initial BWPs, and a number of total paging frames in the DRX cycle of the UE per initial BWP; and determine a paging occasion of the UE based at least in part on the ID of the UE, the index of the initial BWP, the number of initial BWPs in the plurality of initial BWPs, the number of total paging frames in the DRX cycle of the UE per initial BWP, and a number of paging occasions for a PF per initial BWP.

The controller 1606 may manage input and output signals for the UE 1600. The controller 1606 may also manage peripherals not integrated into the UE 1600. In some implementations, the controller 1606 may utilize an operating system such as iOS®, ANDROID®, WINDOWS®, or other operating systems. In some implementations, the controller 1606 may be implemented as part of the processor 1602.

In some implementations, the UE 1600 may include at least one transceiver 1608. In some other implementations, the UE 1600 may have more than one transceiver 1608. The transceiver 1608 may represent a wireless transceiver. The transceiver 1608 may include one or more receiver chains 1610, one or more transmitter chains 1612, or a combination thereof.

A receiver chain 1610 may be configured to receive signals (e.g., control information, data, packets) over a wireless medium. For example, the receiver chain 1610 may include one or more antennas to receive a signal over the air or wireless medium. The receiver chain 1610 may include at least one amplifier (e.g., a low-noise amplifier (LNA)) configured to amplify the received signal. The receiver chain 1610 may include at least one demodulator configured to demodulate the receive signal and obtain the transmitted data by reversing the modulation technique applied during transmission of the signal. The receiver chain 1610 may include at least one decoder for decoding the demodulated signal to receive the transmitted data.

A transmitter chain 1612 may be configured to generate and transmit signals (e.g., control information, data, packets). The transmitter chain 1612 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 1612 may also include at least one power amplifier configured to amplify the modulated signal to an appropriate power level suitable for transmission over the wireless medium. The transmitter chain 1612 may also include one or more antennas for transmitting the amplified signal into the air or wireless medium.

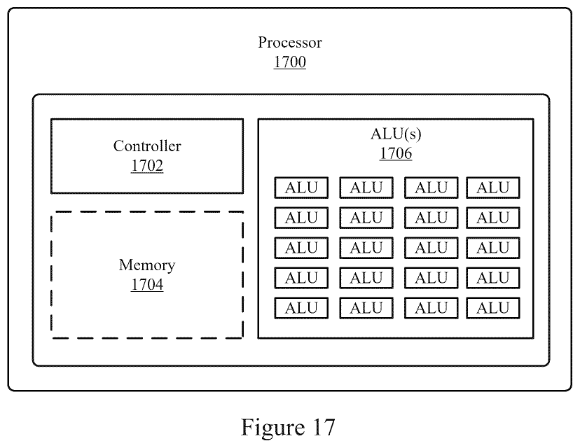

FIG. 17 illustrates an example of a processor 1700 in accordance with aspects of the present disclosure. The processor 1700 may be an example of a processor configured to perform various operations in accordance with examples as described herein. The processor 1700 may include a controller 1702 configured to perform various operations in accordance with examples as described herein. The processor 1700 may optionally include at least one memory 1704, which may be, for example, an L1/L2/L3 cache. Additionally, or alternatively, the processor 1700 may optionally include one or more arithmetic-logic units (ALUs) 1706. One or more of these components may be in electronic communication or otherwise coupled (e.g., operatively, communicatively, functionally, electronically, electrically) via one or more interfaces (e.g., buses).

The processor 1700 may be a processor chipset and include a protocol stack (e.g., a software stack) executed by the processor chipset to perform various operations (e.g., receiving, obtaining, retrieving, transmitting, outputting, forwarding, storing, determining, identifying, accessing, writing, reading) in accordance with examples as described herein. The processor chipset may include one or more cores, one or more caches (e.g., memory local to or included in the processor chipset (e.g., the processor 1700) or other memory (e.g., random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), and others).

The controller 1702 may be configured to manage and coordinate various operations (e.g., signaling, receiving, obtaining, retrieving, transmitting, outputting, forwarding, storing, determining, identifying, accessing, writing, reading) of the processor 1700 to cause the processor 1700 to support various operations in accordance with examples as described herein. For example, the controller 1702 may operate as a control unit of the processor 1700, generating control signals that manage the operation of various components of the processor 1700. These control signals include enabling or disabling functional units, selecting data paths, initiating memory access, and coordinating timing of operations.

The controller 1702 may be configured to fetch (e.g., obtain, retrieve, receive) instructions from the memory 1704 and determine subsequent instruction(s) to be executed to cause the processor 1700 to support various operations in accordance with examples as described herein. The controller 1702 may be configured to track memory addresses of instructions associated with the memory 1704. The controller 1702 may be configured to decode instructions to determine the operation to be performed and the operands involved. For example, the controller 1702 may be configured to interpret the instruction and determine control signals to be output to other components of the processor 1700 to cause the processor 1700 to support various operations in accordance with examples as described herein. Additionally, or alternatively, the controller 1702 may be configured to manage flow of data within the processor 1700. The controller 1702 may be configured to control transfer of data between registers, ALUs 1706, and other functional units of the processor 1700.

The memory 1704 may include one or more caches (e.g., memory local to or included in the processor 1700 or other memory, such as RAM, ROM, DRAM, SDRAM, SRAM, MRAM, flash memory, etc. In some implementations, the memory 1704 may reside within or on a processor chipset (e.g., local to the processor 1700). In some other implementations, the memory 1704 may reside external to the processor chipset (e.g., remote to the processor 1700).

The memory 1704 may store computer-readable, computer-executable code including instructions that, when executed by the processor 1700, cause the processor 1700 to perform various functions described herein. The code may be stored in a non-transitory computer-readable medium such as system memory or another type of memory. The controller 1702 and/or the processor 1700 may be configured to execute computer-readable instructions stored in the memory 1704 to cause the processor 1700 to perform various functions. For example, the processor 1700 and/or the controller 1702 may be coupled with or to the memory 1704, the processor 1700, and the controller 1702, and may be configured to perform various functions described herein. In some examples, the processor 1700 may include multiple processors and the memory 1704 may include multiple memories. One or more of the multiple processors may be coupled with one or more of the multiple memories, which may, individually or collectively, be configured to perform various functions herein.

The one or more ALUs 1706 may be configured to support various operations in accordance with examples as described herein. In some implementations, the one or more ALUs 1706 may reside within or on a processor chipset (e.g., the processor 1700). In some other implementations, the one or more ALUs 1706 may reside external to the processor chipset (e.g., the processor 1700). One or more ALUs 1706 may perform one or more computations such as addition, subtraction, multiplication, and division on data. For example, one or more ALUs 1706 may receive input operands and an operation code, which determines an operation to be executed. One or more ALUs 1706 may be configured with a variety of logical and arithmetic circuits, including adders, subtractors, shifters, and logic gates, to process and manipulate the data according to the operation. Additionally, or alternatively, the one or more ALUs 1706 may support logical operations such as AND, OR, exclusive-OR (XOR), not-OR (NOR), and not-AND (NAND), enabling the one or more ALUs 1706 to handle conditional operations, comparisons, and bitwise operations.

The processor 1700 may support wireless communication in accordance with examples as disclosed herein. The processor 1700 may be configured to or operable to support at least one controller (e.g., the controller 1702) coupled with at least one memory (e.g., the memory 1704) and configured to cause the processor to: receive a first signaling indicating a first SSB of a cell on a first synchronization raster entry; decode a first PBCH associated with the first SSB; identify a second synchronization raster entry of the cell based at least in part on the first PBCH, where the second synchronization raster entry is different from the first synchronization raster entry, and where each of the first synchronization raster entry and the second synchronization raster entry is associated with a different initial BWP of a plurality of initial BWPs of the cell; and camp on an initial BWP of the plurality of initial BWPs of the cell.

Additionally, the processor 1700 may be configured to or operable to support any one or combination of the at least one controller is configured to cause the processor to receive a second signaling indicating a SIB1 of the cell, where the SIB1 is associated with the first SSB, where the second synchronization raster entry of the cell is identified based on the first PBCH and the SIB1, and where the SIB1 includes information describing the plurality of initial BWPs of the cell; select the initial BWP of the plurality of initial BWPs, where the information describing the plurality of initial BWPs of the cell includes association information between each of the plurality of initial BWPs and one of a plurality of synchronization raster entries of the cell, the plurality of synchronization raster entries including the first synchronization raster entry and the second synchronization raster entry, where the second synchronization raster entry of the cell is identified based at least in part on selection of the initial BWP and the association information between the initial BWP and the second synchronization raster entry, and where the initial BWP is associated with the second synchronization raster entry; where for at least one initial BWP of the cell, the information describing the plurality of initial BWPs of the cell in the SIB1 includes a CORESET and a PDCCH search space for monitoring an extended SIB1 in the initial BWP of the cell; where the extended SIB1 transmitted in the initial BWP includes common parameters for the initial BWP; receive a third signaling indicating a second SSB of the cell on a third synchronization raster entry; determine whether the second SSB has an associated SIB1 of the cell; identify the first synchronization raster entry of the cell in response to determining that the second SSB does not have an associated SIB1 of the cell, where the first signaling indicating the first SSB is received upon identification of the first synchronization raster entry of the cell; decode a second PBCH associated with the second SSB, where identification of the first synchronization raster entry of the cell is based at least in part on the second PBCH; where the first PBCH indicates one or more additional synchronization raster entries of a plurality of synchronization raster entries of the cell, and where each of the plurality of synchronization raster entries is associated with a different initial BWP of the plurality of initial BWPs of the cell; select the second synchronization raster entry of the plurality of synchronization raster entries of the cell; receive a second signaling indicating a second SSB of the cell on the second synchronization raster entry of the cell; and receive a third signaling indicating a SIB1 of the cell, where the SIB1 is associated with the second SSB, where camping on the initial BWP is based at least in part on the second SSB and the SIB1 associated with the second SSB; select the first synchronization raster entry of the plurality of synchronization raster entries of the cell; and receive a second signaling indicating a SIB1 of the cell, where the SIB1 is associated with the first SSB, and where camping on the initial BWP is based at least in part on the first SSB and the SIB1 associated with the first SSB; receive a second signaling indicating a SIB1 of the cell, where the SIB1 includes layer 2 and layer 3 configuration information for the cell; receive a second signaling indicating a number of initial BWPs in the plurality of initial BWPs of the cell; receive a second signaling indicating a plurality of cell-specific BWP configurations of the cell; receive a third signaling indicating a plurality of UE-specific BWP configurations of the cell; receive association information between each of the plurality of cell-specific BWP configurations and one of the plurality of UE-specific BWP configurations; and use a cell-specific BWP configuration of the plurality of cell-specific BWP configurations and a UE-specific BWP configuration of the plurality of UE-specific BWP configurations for communication in a BWP, where the UE-specific BWP configuration is associated with the cell-specific BWP configuration and is identified based on the association information.

The processor 1700 may support wireless communication in accordance with examples as disclosed herein. The processor 1700 may be configured to or operable to support at least one controller (e.g., the controller 1702) coupled with at least one memory (e.g., the memory 1704) and configured to cause the processor to: receive a first signaling indicating a plurality of initial BWP of a cell; select, based at least in part on an ID of a UE that includes the processor, an initial BWP from the plurality of initial BWPs; monitor paging DCI in the selected initial BWP of the cell.

Additionally, the processor 1700 may be configured to or operable to support any one or combination of the at least one controller is configured to cause the processor to detect a SSB of the cell on a first synchronization raster entry; decode a PBCH associated with the SSB; and determine, based at least in part on the PBCH, that the cell is not barred and that the SSB has an associated SIB1 of the cell in a first initial BWP associated with the first synchronization raster entry, where to receive the first signaling is to receive the SIB1 in the first initial BWP, and where the SIB1 includes the indication of the plurality of initial BWPs; where the selected initial BWP includes a second initial BWP; acquire an extended SIB1 in the second initial BWP; and use parameters configured in the extended SIB1 of the second initial BWP for monitoring the paging DCI in the second initial BWP; detect a first SSB of a cell on a first synchronization raster entry; decode a PBCH associated with the first SSB; determine, based at least in part on the PBCH, that the cell is not barred, that the first SSB is associated with an extended SIB1 of the cell in a first initial BWP associated with the first synchronization raster entry, and that a SIB1 of the cell is transmitted in a second initial BWP associated with a second synchronization raster entry; detect a second SSB of the cell on the second synchronization raster entry; and receive the SIB1 of the cell in the second initial BWP, where to receive the first signaling is to receive the SIB1 in the second initial BWP, and where the SIB1 includes the indication of the plurality of initial BWPs; where to select the initial BWP is to select the initial BWP based at least in part on the ID of the UE and at least one of a DRX cycle of the UE, a number of initial BWPs in the plurality of initial BWPs, a number of total paging frames in the DRX cycle of the UE per initial BWP, and a number of paging occasions for a PF per initial BWP; determine a PF of the UE based at least in part on the ID of the UE, an index of the selected initial BWP, a DRX cycle of the UE, a number of initial BWPs in the plurality of initial BWPs, and a number of total paging frames in the DRX cycle of the UE per initial BWP; and determine a paging occasion of the UE based at least in part on the ID of the UE, the index of the selected initial BWP, the number of initial BWPs in the plurality of initial BWPs, the number of total paging frames in the DRX cycle of the UE per initial BWP, and a number of paging occasions for a PF per initial BWP.

The processor 1700 may support wireless communication in accordance with examples as disclosed herein. The processor 1700 may be configured to or operable to support at least one controller (e.g., the controller 1702) coupled with at least one memory (e.g., the memory 1704) and configured to cause the processor to: receive a first signaling indicating a plurality of synchronization raster entries of a cell, where each of the plurality of synchronization raster entries is associated with a distinctive initial BWP of a plurality of initial BWPs of the cell; select, based at least in part on an ID of a UE that includes the processor, a synchronization raster entry from the plurality of synchronization raster entries; determine one or more parameters for an initial BWP of the cell associated with the selected synchronization raster entry; monitor paging DCI based at least in part on the determined parameters for the initial BWP of the cell.

Additionally, the processor 1700 may be configured to or operable to support any one or combination of the at least one controller is configured to cause the processor to detect a SSB of the cell on the selected synchronization raster entry; decode a PBCH associated with the SSB; determine, based at least in part on the PBCH, that the cell is not barred and that the SSB has an associated SIB1 of the cell, where the first signaling is received at least in part in the PBCH; and receive the SIB1 in the initial BWP associated with the selected synchronization raster entry upon selection of the synchronization raster entry, where the SIB1 includes the one or more parameters for the initial BWP; detect a first SSB of the cell on a first synchronization raster entry of the plurality of synchronization raster entries of the cell, where the selected synchronization raster entry is a second synchronization raster entry, and where the first synchronization raster entry is different from the second synchronization raster entry; decode a PBCH associated with the first SSB; determine, based at least in part on the PBCH, that the cell is not barred and that the first SSB has an associated SIB1 of the cell in a first initial BWP associated with the first synchronization raster entry, where the first signaling is received at least in part in the PBCH; detect a second SSB of the cell on the second synchronization raster entry upon selection of the second synchronization raster entry; and receive a SIB1 of the cell in a second initial BWP associated with the second synchronization raster entry, where the SIB1 includes the one or more parameters for the second initial BWP; where to select the synchronization raster entry is to select the synchronization raster entry based at least in part on the ID of the UE and at least one of a DRX cycle of the UE, a number of initial BWPs in the plurality of initial BWPs, a number of total paging frames in the DRX cycle of the UE per initial BWP, and a number of paging occasions for a PF per initial BWP; determine a PF of the UE based at least in part on the ID of the UE, an index of the initial BWP, a DRX cycle of the UE, a number of initial BWPs in the plurality of initial BWPs, and a number of total paging frames in the DRX cycle of the UE per initial BWP; and determine a paging occasion of the UE based at least in part on the ID of the UE, the index of the initial BWP, the number of initial BWPs in the plurality of initial BWPs, the number of total paging frames in the DRX cycle of the UE per initial BWP, and a number of paging occasions for a PF per initial BWP.

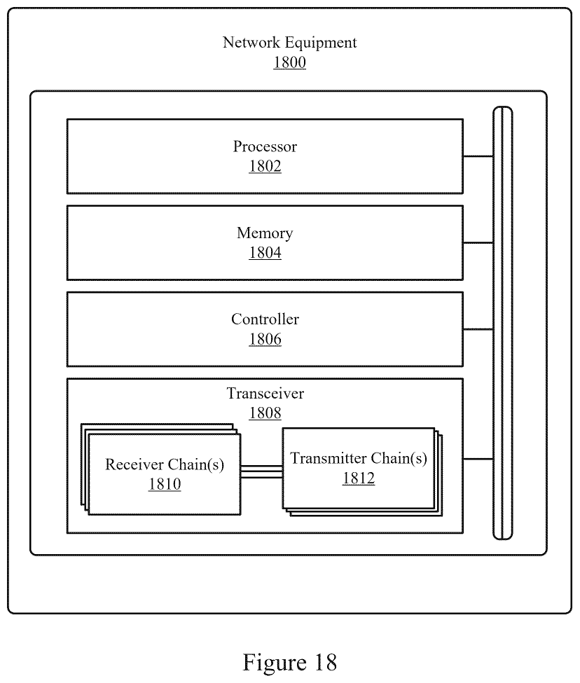

FIG. 18 illustrates an example of a NE 1800 in accordance with aspects of the present disclosure. The NE 1800 may include a processor 1802, a memory 1804, a controller 1806, and a transceiver 1808. The processor 1802, the memory 1804, the controller 1806, or the transceiver 1808, or various combinations thereof or various components thereof may be examples of means for performing various aspects of the present disclosure as described herein. These components may be coupled (e.g., operatively, communicatively, functionally, electronically, electrically) via one or more interfaces.

The processor 1802, the memory 1804, the controller 1806, or the transceiver 1808, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 1802 may include an intelligent hardware device (e.g., a general-purpose processor, a DSP, a CPU, an ASIC, an FPGA, or any combination thereof). In some implementations, the processor 1802 may be configured to operate the memory 1804. In some other implementations, the memory 1804 may be integrated into the processor 1802. The processor 1802 may be configured to execute computer-readable instructions stored in the memory 1804 to cause the NE 1800 to perform various functions of the present disclosure.

The memory 1804 may include volatile or non-volatile memory. The memory 1804 may store computer-readable, computer-executable code including instructions when executed by the processor 1802 cause the NE 1800 to perform various functions described herein. The code may be stored in a non-transitory computer-readable medium such as the memory 1804 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 1802 and the memory 1804 coupled with the processor 1802 may be configured to cause the NE 1800 to perform one or more of the functions described herein (e.g., executing, by the processor 1802, instructions stored in the memory 1804). For example, the processor 1802 may support wireless communication at the NE 1800 in accordance with examples as disclosed herein. The NE 1800 may be configured to support a means for transmitting a first signaling indicating a first SSB of a cell on a first synchronization raster entry associated with a first initial BWP of a plurality of initial BWPs of the cell; and transmitting a second signaling indicating a second SSB of the cell on a second synchronization raster entry associated with a second initial BWP of the plurality of initial BWPs of the cell.

Additionally, the NE 1800 may be configured to support any one or combination of transmitting a third signaling indicating a SIB1 of the cell, where the SIB1 is associated with the first SSB or the second SSB, and where the SIB1 includes information describing the plurality of initial BWPs of the cell; where for at least one initial BWP of the cell, the information describing the plurality of initial BWPs of the cell in the SIB1 includes a CORESET and a PDCCH search space for monitoring an extended SIB1 in an initial BWP of the cell; where the extended SIB1 transmitted in the initial BWP includes common parameters for the initial BWP; transmitting a third signaling indicating a SIB1 of the cell, where the SIB1 includes layer 2 and layer 3 configuration information for the cell; transmitting a third signaling indicating a number of initial BWPs in the plurality of initial BWPs of the cell; transmitting a third signaling indicating a plurality of cell-specific BWP configurations and a plurality of UE-specific BWP configurations of the cell; and transmitting a fourth signaling indicating association information between each of the plurality of cell-specific BWP configurations and one of the plurality of UE-specific BWP configurations.

Additionally, or alternatively, the NE 1800 may support at least one memory (e.g., the memory 1804) and at least one processor (e.g., the processor 1802) coupled with the at least one memory and configured to cause the NE to: transmit a first signaling indicating a first SSB of a cell on a first synchronization raster entry associated with a first initial BWP of a plurality of initial BWPs of the cell; transmit a second signaling indicating a second SSB of the cell on a second synchronization raster entry associated with a second initial BWP of the plurality of initial BWPs of the cell.

Additionally, the NE 1800 may be configured to support any one or combination of the at least one processor is configured to cause the NE to transmit a third signaling indicating a SIB1 of the cell, where the SIB1 is associated with the first SSB or the second SSB, and where the SIB1 includes information describing the plurality of initial BWPs of the cell; where for at least one initial BWP of the cell, the information describing the plurality of initial BWPs of the cell in the SIB1 includes a CORESET and a PDCCH search space for monitoring an extended SIB1 in an initial BWP of the cell; where the extended SIB1 transmitted in the initial BWP includes common parameters for the initial BWP; transmit a third signaling indicating a SIB1 of the cell, where the SIB1 includes layer 2 and layer 3 configuration information for the cell; transmit a third signaling indicating a number of initial BWPs in the plurality of initial BWPs of the cell; transmit a third signaling indicating a plurality of cell-specific BWP configurations and a plurality of UE-specific BWP configurations of the cell; and transmit a fourth signaling indicating association information between each of the plurality of cell-specific BWP configurations and one of the plurality of UE-specific BWP configurations.

In some implementations, the processor 1802 and the memory 1804 coupled with the processor 1802 may be configured to cause the NE 1800 to perform one or more of the functions described herein (e.g., executing, by the processor 1802, instructions stored in the memory 1804). For example, the processor 1802 may support wireless communication at the NE 1800 in accordance with examples as disclosed herein. The NE 1800 may be configured to support a means for transmitting a first signaling indicating a plurality of initial BWP of a cell; and transmitting, in each of the plurality of BWPs, a second signaling indicating paging DCI for the cell.

In some implementations, the processor 1802 and the memory 1804 coupled with the processor 1802 may be configured to cause the NE 1800 to perform one or more of the functions described herein (e.g., executing, by the processor 1802, instructions stored in the memory 1804). For example, the processor 1802 may support wireless communication at the NE 1800 in accordance with examples as disclosed herein. The NE 1800 may be configured to support a means for transmitting a first signaling indicating a plurality of synchronization raster entries of a cell, where each of the plurality of synchronization raster entries is associated with a distinctive initial BWP of a plurality of initial BWPs of the cell; transmitting, in each of the plurality of initial BWPs of the cell, paging DCI for the cell.

Additionally, or alternatively, the NE 1800 may support at least one memory (e.g., the memory 1804) and at least one processor (e.g., the processor 1802) coupled with the at least one memory and configured to cause the NE to: transmit a first signaling indicating a plurality of initial BWP of a cell; transmit, in each of the plurality of BWPs, a second signaling indicating paging DCI for the cell.

Additionally, or alternatively, the NE 1800 may support at least one memory (e.g., the memory 1804) and at least one processor (e.g., the processor 1802) coupled with the at least one memory and configured to cause the NE to: transmit a first signaling indicating a plurality of synchronization raster entries of a cell, where each of the plurality of synchronization raster entries is associated with a distinctive initial BWP of a plurality of initial BWPs of the cell; transmit, in each of the plurality of initial BWPs of the cell, paging DCI for the cell.

The controller 1806 may manage input and output signals for the NE 1800. The controller 1806 may also manage peripherals not integrated into the NE 1800. In some implementations, the controller 1806 may utilize an operating system such as iOS®, ANDROID®, WINDOWS®, or other operating systems. In some implementations, the controller 1806 may be implemented as part of the processor 1802.

In some implementations, the NE 1800 may include at least one transceiver 1808. In some other implementations, the NE 1800 may have more than one transceiver 1808. The transceiver 1808 may represent a wireless transceiver. The transceiver 1808 may include one or more receiver chains 1810, one or more transmitter chains 1812, or a combination thereof.

A receiver chain 1810 may be configured to receive signals (e.g., control information, data, packets) over a wireless medium. For example, the receiver chain 1810 may include one or more antennas to receive a signal over the air or wireless medium. The receiver chain 1810 may include at least one amplifier (e.g., a low-noise amplifier (LNA)) configured to amplify the received signal. The receiver chain 1810 may include at least one demodulator configured to demodulate the receive signal and obtain the transmitted data by reversing the modulation technique applied during transmission of the signal. The receiver chain 1810 may include at least one decoder for decoding the demodulated signal to receive the transmitted data.

A transmitter chain 1812 may be configured to generate and transmit signals (e.g., control information, data, packets). The transmitter chain 1812 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 1812 may also include at least one power amplifier configured to amplify the modulated signal to an appropriate power level suitable for transmission over the wireless medium. The transmitter chain 1812 may also include one or more antennas for transmitting the amplified signal into the air or wireless medium.

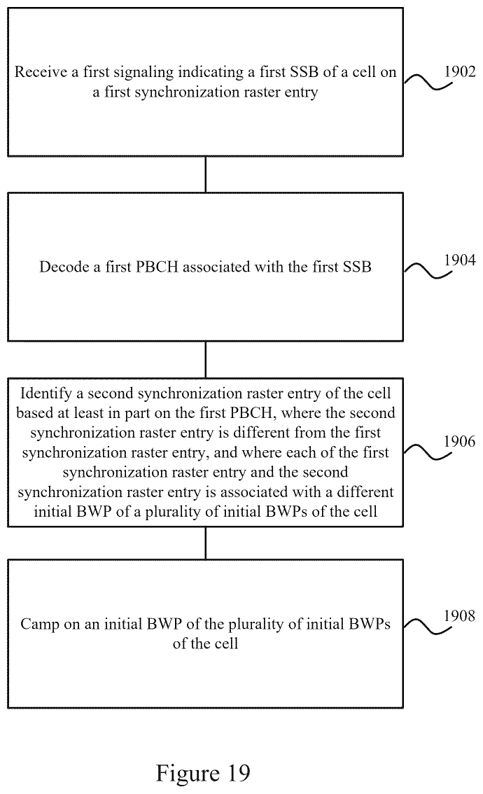

FIG. 19 illustrates a flowchart of a method in accordance with aspects of the present disclosure. The operations of the method may be implemented by a UE as described herein. In some implementations, the UE may execute a set of instructions to control the function elements of the UE to perform the described functions.

At 1902, the method may include receiving a first signaling indicating a first SSB of a cell on a first synchronization raster entry. The operations of 1902 may be performed in accordance with examples as described herein. In some implementations, aspects of the operations of 1902 may be performed by a UE as described with reference to FIG. 16.

At 1904, the method may include decoding a first PBCH associated with the first SSB. The operations of 1904 may be performed in accordance with examples as described herein. In some implementations, aspects of the operations of 1904 may be performed by a UE as described with reference to FIG. 16.

At 1906, the method may include identifying a second synchronization raster entry of the cell based at least in part on the first PBCH, where the second synchronization raster entry is different from the first synchronization raster entry, and where each of the first synchronization raster entry and the second synchronization raster entry is associated with a different initial BWP of a plurality of initial BWPs of the cell. The operations of 1906 may be performed in accordance with examples as described herein. In some implementations, aspects of the operations of 1906 may be performed a UE as described with reference to FIG. 16.

At 1908, the method may include camping on an initial BWP of the plurality of initial BWPs of the cell. The operations of 1908 may be performed in accordance with examples as described herein. In some implementations, aspects of the operations of 1908 may be performed a UE as described with reference to FIG. 16.

It should be noted that the method described herein describes a possible implementation, and that the operations and the steps may be rearranged or otherwise modified and that other implementations are possible.

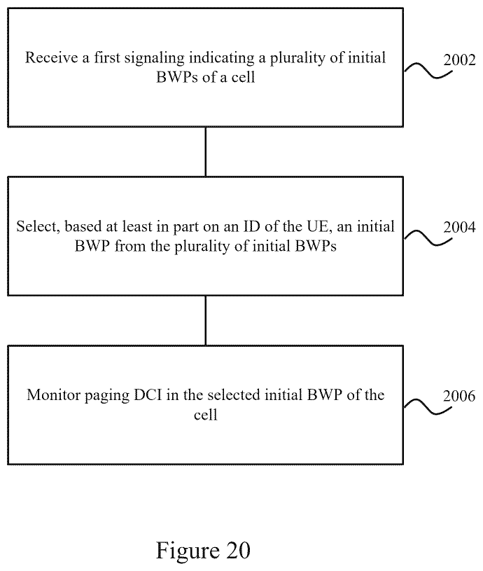

FIG. 20 illustrates a flowchart of a method in accordance with aspects of the present disclosure. The operations of the method may be implemented by a UE as described herein. In some implementations, the UE may execute a set of instructions to control the function elements of the UE to perform the described functions.

At 2002, the method may include receiving a first signaling indicating a plurality of initial BWPs of a cell. The operations of 2002 may be performed in accordance with examples as described herein. In some implementations, aspects of the operations of 2002 may be performed by a UE as described with reference to FIG. 16.

At 2004, the method may include selecting, based at least in part on an ID of the UE, an initial BWP from the plurality of initial BWPs. The operations of 2004 may be performed in accordance with examples as described herein. In some implementations, aspects of the operations of 2004 may be performed by a UE as described with reference to FIG. 16.

At 2006, the method may include monitoring paging DCI in the selected initial BWP of the cell. The operations of 2006 may be performed in accordance with examples as described herein. In some implementations, aspects of the operations of 2006 may be performed a UE as described with reference to FIG. 16.

It should be noted that the method described herein describes a possible implementation, and that the operations and the steps may be rearranged or otherwise modified and that other implementations are possible.

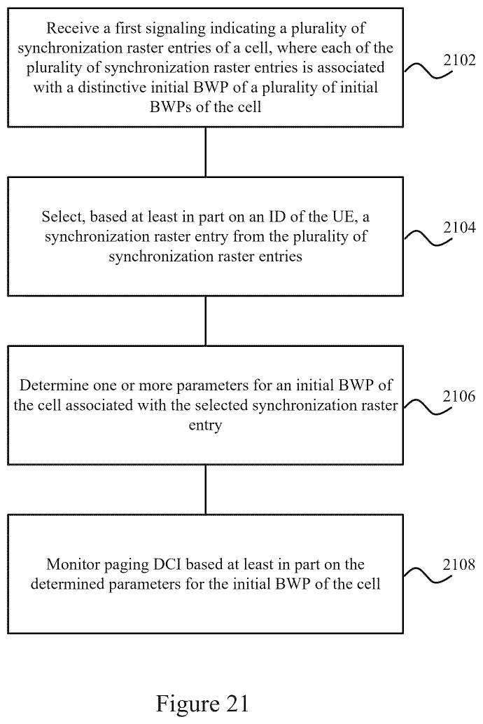

FIG. 21 illustrates a flowchart of a method in accordance with aspects of the present disclosure. The operations of the method may be implemented by a UE as described herein. In some implementations, the UE may execute a set of instructions to control the function elements of the UE to perform the described functions.

At 2102, the method may include receiving a first signaling indicating a plurality of synchronization raster entries of a cell, where each of the plurality of synchronization raster entries is associated with a distinctive initial BWP of a plurality of initial BWPs of the cell. The operations of 2102 may be performed in accordance with examples as described herein. In some implementations, aspects of the operations of 2102 may be performed by a UE as described with reference to FIG. 16.

At 2104, the method may include selecting, based at least in part on an ID of the UE, a synchronization raster entry from the plurality of synchronization raster entries. The operations of 2104 may be performed in accordance with examples as described herein. In some implementations, aspects of the operations of 2104 may be performed by a UE as described with reference to FIG. 16.

At 2106, the method may include determining one or more parameters for an initial BWP of the cell associated with the selected synchronization raster entry. The operations of 2106 may be performed in accordance with examples as described herein. In some implementations, aspects of the operations of 2106 may be performed a UE as described with reference to FIG. 16.

At 2108, the method may include monitoring paging DCI based at least in part on the determined parameters for the initial BWP of the cell. The operations of 2108 may be performed in accordance with examples as described herein. In some implementations, aspects of the operations of 2108 may be performed a UE as described with reference to FIG. 16.

It should be noted that the method described herein describes a possible implementation, and that the operations and the steps may be rearranged or otherwise modified and that other implementations are possible.

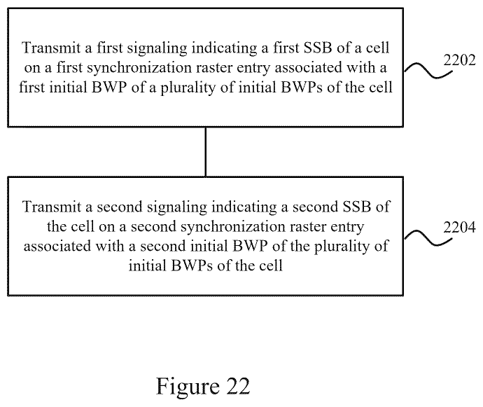

FIG. 22 illustrates a flowchart of a method in accordance with aspects of the present disclosure. The operations of the method may be implemented by a NE as described herein. In some implementations, the NE may execute a set of instructions to control the function elements of the NE to perform the described functions.

At 2202, the method may include transmitting a first signaling indicating a first SSB of a cell on a first synchronization raster entry associated with a first initial BWP of a plurality of initial BWPs of the cell. The operations of 2202 may be performed in accordance with examples as described herein. In some implementations, aspects of the operations of 2202 may be performed by a NE as described with reference to FIG. 18.

At 2204, the method may include transmitting a second signaling indicating a second SSB of the cell on a second synchronization raster entry associated with a second initial BWP of the plurality of initial BWPs of the cell. The operations of 2204 may be performed in accordance with examples as described herein. In some implementations, aspects of the operations of 2204 may be performed by a NE as described with reference to FIG. 18.

It should be noted that the method described herein describes a possible implementation, and that the operations and the steps may be rearranged or otherwise modified and that other implementations are possible.

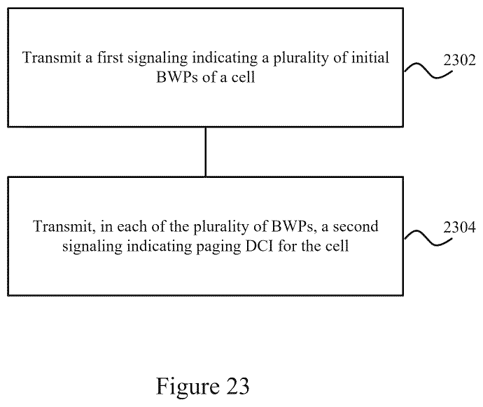

FIG. 23 illustrates a flowchart of a method in accordance with aspects of the present disclosure. The operations of the method may be implemented by a NE as described herein. In some implementations, the NE may execute a set of instructions to control the function elements of the NE to perform the described functions.

At 2302, the method may include transmitting a first signaling indicating a plurality of initial BWPs of a cell. The operations of 2302 may be performed in accordance with examples as described herein. In some implementations, aspects of the operations of 2302 may be performed by a NE as described with reference to FIG. 18.

At 2304, the method may include transmitting, in each of the plurality of BWPs, a second signaling indicating paging DCI for the cell. The operations of 2304 may be performed in accordance with examples as described herein. In some implementations, aspects of the operations of 2304 may be performed by a NE as described with reference to FIG. 18.

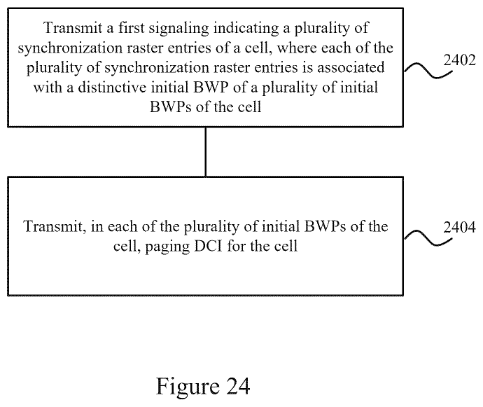

FIG. 24 illustrates a flowchart of a method in accordance with aspects of the present disclosure. The operations of the method may be implemented by a NE as described herein. In some implementations, the NE may execute a set of instructions to control the function elements of the NE to perform the described functions.

At 2402, the method may include transmitting a first signaling indicating a plurality of synchronization raster entries of a cell, where each of the plurality of synchronization raster entries is associated with a distinctive initial BWP of a plurality of initial BWPs of the cell. The operations of 2402 may be performed in accordance with examples as described herein. In some implementations, aspects of the operations of 2402 may be performed by a NE as described with reference to FIG. 18.

At 2404, the method may include transmitting, in each of the plurality of initial BWPs of the cell, paging DCI for the cell. The operations of 2404 may be performed in accordance with examples as described herein. In some implementations, aspects of the operations of 2404 may be performed by a NE as described with reference to FIG. 18.

It should be noted that the method described herein describes a possible implementation, and that the operations and the steps may be rearranged or otherwise modified and that other implementations are possible.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE) for wireless communication, comprising:
at least one memory; and
at least one processor coupled with the at least one memory and configured to cause the UE to:
receive a first signaling indicating a plurality of initial bandwidth parts (BWPs) of a cell;
select, based at least in part on an identity (ID) of the UE, an initial BWP from the plurality of initial BWPs; and
monitor paging downlink control information (DCI) in the selected initial BWP of the cell.

2. The UE of claim 1, wherein the at least one processor is further configured to cause the UE to:
detect a synchronization signal block (SSB) of the cell on a first synchronization raster entry;
decode a physical broadcast channel (PBCH) associated with the SSB; and
determine, based at least in part on the PBCH, that the cell is not barred and that the SSB has an associated system information block Type1 (SIB1) of the cell in a first initial BWP associated with the first synchronization raster entry, wherein to receive the first signaling is to receive the SIB1 in the first initial BWP, and wherein the SIB1 comprises the indication of the plurality of initial BWPs.

3. The UE of claim 2, wherein the selected initial BWP comprises a second initial BWP, and wherein the at least one processor is further configured to cause the UE to:
acquire an extended SIB1 in the second initial BWP; and
use parameters configured in the extended SIB1 of the second initial BWP for monitoring the paging DCI in the second initial BWP.

4. The UE of claim 1, wherein the at least one processor is further configured to cause the UE to:
detect a first synchronization signal block (SSB) of a cell on a first synchronization raster entry;
decode a physical broadcast channel (PBCH) associated with the first SSB;
determine, based at least in part on the PBCH, that the cell is not barred, that the first SSB is associated with an extended system information block Type1 (SIB1) of the cell in a first initial BWP associated with the first synchronization raster entry, and that a SIB1 of the cell is transmitted in a second initial BWP associated with a second synchronization raster entry;
detect a second SSB of the cell on the second synchronization raster entry; and
receive the SIB1 of the cell in the second initial BWP, wherein to receive the first signaling is to receive the SIB1 in the second initial BWP, and wherein the SIB1 comprises the indication of the plurality of initial BWPs.

5. The UE of claim 1, wherein to select the initial BWP is to select the initial BWP based at least in part on the ID of the UE and at least one of a discontinuous reception (DRX) cycle of the UE, a number of initial BWPs in the plurality of initial BWPs, a number of total paging frames in the DRX cycle of the UE per initial BWP, and a number of paging occasions for a paging frame (PF) per initial BWP.

6. The UE of claim 1, wherein the at least one processor is further configured to cause the UE to:
determine a paging frame (PF) of the UE based at least in part on the ID of the UE, an index of the selected initial BWP, a discontinuous reception (DRX) cycle of the UE, a number of initial BWPs in the plurality of initial BWPs, and a number of total paging frames in the DRX cycle of the UE per initial BWP; and
determine a paging occasion of the UE based at least in part on the ID of the UE, the index of the selected initial BWP, the number of initial BWPs in the plurality of initial BWPs, the number of total paging frames in the DRX cycle of the UE per initial BWP, and a number of paging occasions for a PF per initial BWP.

7. A user equipment (UE) for wireless communication, comprising:
at least one memory; and
at least one processor coupled with the at least one memory and configured to cause the UE to:
receive a first signaling indicating a plurality of synchronization raster entries of a cell, wherein each of the plurality of synchronization raster entries is associated with a distinctive initial bandwidth part (BWP) of a plurality of initial BWPs of the cell;
select, based at least in part on an identity (ID) of the UE, a synchronization raster entry from the plurality of synchronization raster entries;
determine one or more parameters for an initial BWP of the cell associated with the selected synchronization raster entry; and
monitor paging downlink control information (DCI) based at least in part on the determined parameters for the initial BWP of the cell.

8. The UE of claim 7, wherein the at least one processor is further configured to cause the UE to:
detect a synchronization signal block (SSB) of the cell on the selected synchronization raster entry;
decode a physical broadcast channel (PBCH) associated with the SSB;
determine, based at least in part on the PBCH, that the cell is not barred and that the SSB has an associated system information block Type1 (SIB1) of the cell, wherein the first signaling is received at least in part in the PBCH; and
receive the SIB1 in the initial BWP associated with the selected synchronization raster entry upon selection of the synchronization raster entry, wherein the SIB1 comprises the one or more parameters for the initial BWP.

9. The UE of claim 7, wherein the at least one processor is further configured to cause the UE to:
detect a first synchronization signal block (SSB) of the cell on a first synchronization raster entry of the plurality of synchronization raster entries of the cell, wherein the selected synchronization raster entry is a second synchronization raster entry, and wherein the first synchronization raster entry is different from the second synchronization raster entry;
decode a physical broadcast channel (PBCH) associated with the first SSB;
determine, based at least in part on the PBCH, that the cell is not barred and that the first SSB has an associated system information block Type1 (SIB1) of the cell in a first initial BWP associated with the first synchronization raster entry, wherein the first signaling is received at least in part in the PBCH;
detect a second SSB of the cell on the second synchronization raster entry upon selection of the second synchronization raster entry; and
receive a SIB1 of the cell in a second initial BWP associated with the second synchronization raster entry, wherein the SIB1 comprises the one or more parameters for the second initial BWP.

10. The UE of claim 7, wherein to select the synchronization raster entry is to select the synchronization raster entry based at least in part on the ID of the UE and at least one of a discontinuous reception (DRX) cycle of the UE, a number of initial BWPs in the plurality of initial BWPs, a number of total paging frames in the DRX cycle of the UE per initial BWP, and a number of paging occasions for a paging frame (PF) per initial BWP.

11. The UE of claim 7, wherein the at least one processor is further configured to cause the UE to:
determine a paging frame (PF) of the UE based at least in part on the ID of the UE, an index of the initial BWP, a discontinuous reception (DRX) cycle of the UE, a number of initial BWPs in the plurality of initial BWPs, and a number of total paging frames in the DRX cycle of the UE per initial BWP; and
determine a paging occasion of the UE based at least in part on the ID of the UE, the index of the initial BWP, the number of initial BWPs in the plurality of initial BWPs, the number of total paging frames in the DRX cycle of the UE per initial BWP, and a number of paging occasions for a PF per initial BWP.

12. A processor for wireless communication, comprising:
at least one controller coupled with at least one memory and configured to cause the processor to:
receive a first signaling indicating a plurality of initial bandwidth parts (BWPs) of a cell;
select, based at least in part on an identity (ID) of a user equipment (UE) that includes the processor, an initial BWP from the plurality of initial BWPs; and
monitor paging downlink control information (DCI) in the selected initial BWP of the cell.

13. The processor of claim 12, wherein the at least one controller is further configured to cause the processor to:
detect a synchronization signal block (SSB) of the cell on a first synchronization raster entry;
decode a physical broadcast channel (PBCH) associated with the SSB; and
determine, based at least in part on the PBCH, that the cell is not barred and that the SSB has an associated system information block Type1 (SIB1) of the cell in a first initial BWP associated with the first synchronization raster entry, wherein to receive the first signaling is to receive the SIB1 in the first initial BWP, and wherein the SIB1 comprises the indication of the plurality of initial BWPs.

14. The processor of claim 13, wherein the selected initial BWP comprises a second initial BWP, and wherein the at least one controller is further configured to cause the processor to:
acquire an extended SIB1 in the second initial BWP; and
use parameters configured in the extended SIB1 of the second initial BWP for monitoring the paging DCI in the second initial BWP.

15. The processor of claim 12, wherein the at least one controller is further configured to cause the processor to:
detect a first synchronization signal block (SSB) of a cell on a first synchronization raster entry;
decode a physical broadcast channel (PBCH) associated with the first SSB;
determine, based at least in part on the PBCH, that the cell is not barred, that the first SSB is associated with an extended system information block Type1 (SIB1) of the cell in a first initial BWP associated with the first synchronization raster entry, and that a SIB1 of the cell is transmitted in a second initial BWP associated with a second synchronization raster entry;
detect a second SSB of the cell on the second synchronization raster entry; and
receive the SIB1 of the cell in the second initial BWP, wherein to receive the first signaling is to receive the SIB1 in the second initial BWP, and wherein the SIB1 comprises the indication of the plurality of initial BWPs.

16. The processor of claim 12, wherein to select the initial BWP is to select the initial BWP based at least in part on the ID of the UE and at least one of a discontinuous reception (DRX) cycle of the UE, a number of initial BWPs in the plurality of initial BWPs, a number of total paging frames in the DRX cycle of the UE per initial BWP, and a number of paging occasions for a paging frame (PF) per initial BWP.

17. A processor for wireless communication, comprising:
at least one controller coupled with at least one memory and configured to cause the processor to:
receive a first signaling indicating a plurality of synchronization raster entries of a cell, wherein each of the plurality of synchronization raster entries is associated with a distinctive initial bandwidth part (BWP) of a plurality of initial BWPs of the cell;
select, based at least in part on an identity (ID) of a user equipment (UE) that includes the processor, a synchronization raster entry from the plurality of synchronization raster entries;
determine one or more parameters for an initial BWP of the cell associated with the selected synchronization raster entry; and
monitor paging downlink control information (DCI) based at least in part on the determined parameters for the initial BWP of the cell.

18. The processor of claim 17, wherein the at least one controller is further configured to cause the processor to:
detect a synchronization signal block (SSB) of the cell on the selected synchronization raster entry;
decode a physical broadcast channel (PBCH) associated with the SSB;
determine, based at least in part on the PBCH, that the cell is not barred and that the SSB has an associated system information block Type1 (SIB1) of the cell, wherein the first signaling is received at least in part in the PBCH; and
receive the SIB1 in the initial BWP associated with the selected synchronization raster entry upon selection of the synchronization raster entry, wherein the SIB1 comprises the one or more parameters for the initial BWP.

19. The processor of claim 17, wherein the at least one controller is further configured to cause the processor to:
detect a first synchronization signal block (SSB) of the cell on a first synchronization raster entry of the plurality of synchronization raster entries of the cell, wherein the selected synchronization raster entry is a second synchronization raster entry, and wherein the first synchronization raster entry is different from the second synchronization raster entry;
decode a physical broadcast channel (PBCH) associated with the first SSB;
determine, based at least in part on the PBCH, that the cell is not barred and that the first SSB has an associated system information block Type1 (SIB1) of the cell in a first initial BWP associated with the first synchronization raster entry, wherein the first signaling is received at least in part in the PBCH;
detect a second SSB of the cell on the second synchronization raster entry upon selection of the second synchronization raster entry; and
receive a SIB1 of the cell in a second initial BWP associated with the second synchronization raster entry, wherein the SIB1 comprises the one or more parameters for the second initial BWP.

20. The processor of claim 17, wherein the at least one controller is further configured to cause the processor to:
determine a paging frame (PF) of the UE based at least in part on the ID of the UE, an index of the initial BWP, a discontinuous reception (DRX) cycle of the UE, a number of initial BWPs in the plurality of initial BWPs, and a number of total paging frames in the DRX cycle of the UE per initial BWP; and
determine a paging occasion of the UE based at least in part on the ID of the UE, the index of the initial BWP, the number of initial BWPs in the plurality of initial BWPs, the number of total paging frames in the DRX cycle of the UE per initial BWP, and a number of paging occasions for a PF per initial BWP.
